(19) United States
(12) Patent Application Publication
(10) Pub. No.: US 2014/0298482 A1
(43) Pub. Date: Oct. 2, 2014

(54) TERMINAL DEVICE AND DATA PROCESSING METHOD

(71) Applicant: FUJITSU LIMITED, Kawasaki-shi (JP)

(72) Inventors: AYANA SUZUKI, Hachioji (JP); JOJI FURUYA, Yokohama (JP)

(73) Assignee: FUJITSU LIMITED, Kawasaki-shi (JP)

(21) Appl. No.: 14/156,828

(22) Filed: Jan. 16, 2014

(30) Foreign Application Priority Data
Mar. 27, 2013 (JP) 2013-067155

(51) Int. Cl. G06F 21/62

(52) U.S. Cl. CPC G06F 21/62
USPC 726/27

(57) ABSTRACT

A terminal device comprising: a memory configured to store data that has been appended with respective permissibility data representing whether or not provision of the data is permitted and that has been classified into a plurality of different usages; and a processor configured to execute procedure, the procedure comprising: associating a specific application that requests provision of data stored in the memory with a prescribed usage that has been prescribed from out of the plurality of usages; and out of data of the prescribed usage that was associated in the associating, not providing to the application that requested data provision any data appended with the permissibility data representing that provision is not permitted, and providing to the application that requested data provision any data appended with the permissibility data representing that provision is permitted.

### CROSS-REFERENCE TO RELATED APPLICATION

This application is based upon and claims the benefit of priority of the prior Japanese Patent Application No. 2013-067155, filed on Mar. 27, 2013, the entire contents of which are incorporated herein by reference.

### FIELD

The embodiments discussed herein are related to a terminal device and a data processing method.

### BACKGROUND

In a smart device such as a smart phone or a tablet terminal, an application can be downloaded from the internet and installed according to a user command. The installed application accesses data installed on the smart device (such as for example an address book, image data or a schedule book). Access to data by the application is limited by the Operating System (OS) installed on the smart device. Namely, the OS permits the application only to access data that has been permitted in advance from out of the data the application requests to access.

As technology related to access restrictions there is, for example, known technology in which a right, indicating whether or not access is permitted to a certain type of data, is given to each group to which plural users belong. There is also other known technology in which specific policy data is derived from abstract policy data held by an application based on a table in which specific policy data is associated with abstract policy data. Specific policy data means policy data denoting rules for executing access control to resources, and abstract policy data means policy data denoting rules that are more abstract than for specific policy data.

### RELATED PATENT DOCUMENTS

Japanese Patent Application Laid-Open (JP-A) No. H11-194974
JP-A No. 2007-87248

### SUMMARY

According to an aspect of the embodiments, a terminal device including: a memory configured to store data that has been appended with respective permissibility data representing whether or not provision of the data is permitted and that has been classified into a plurality of different usages; and a processor configured to execute procedure, the procedure comprising: associating a specific application that requests provision of data stored in the memory with a prescribed usage that has been prescribed from out of the plurality of usages; and out of data of the prescribed usage that was associated in the associating, not providing to the application that requested data provision any data appended with the permissibility data representing that provision is not permitted, and providing to the application that requested data provision any data appended with the permissibility data representing that provision is permitted.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a functional block diagram illustrating an example of main functions of a smart device according to a first exemplary embodiment;

FIG. 2 is a schematic diagram illustrating examples of each configuration of a usage specific table containing access control policy data, a group list table and an application list table according to a first exemplary embodiment;

FIG. 3 is a schematic diagram illustrating an example of a configuration of a high level classification specification table;

FIG. 4 is block diagram illustrating an example of main functions of an electrical systems of a smart device according to the first exemplary embodiment;

FIG. 5 is a flow chart illustrating an example of a flow of data provision processing according to the first exemplary embodiment and a second exemplary embodiment;

FIG. 6 is a flow chart illustrating an example of flow of processing at installation included in data provision processing according to the first exemplary embodiment;

FIG. 7 is a schematic diagram illustrating an example of a setting guidance screen displayed on a display section by performing processing at installation according to the first exemplary embodiment;

FIG. 8 is a flow chart illustrating an example of a flow of setting processing according to the first exemplary embodiment;

FIG. 9 is a schematic diagram illustrating an example of a setting screen displayed on a display section by performing processing at installation according to the first exemplary embodiment;

FIG. 10 is a flow chart illustrating an example of flow of permissibility data setting processing according to the first exemplary embodiment;

FIG. 11 is a schematic diagram illustrating an example of a first permissibility data setting screen displayed on a display section by performing permissibility data setting processing according to the first exemplary embodiment;

FIG. 12 is a schematic diagram illustrating an example of a setting complete screen displayed on a display section by performing setting processing included in processing at installation according to the first exemplary embodiment;

FIG. 13 is a flow chart illustrating an example of flow of post setting instruction processing according to the first exemplary embodiment;

FIG. 14 is a flow chart illustrating an example of flow of access permissibility data setting group selection processing according to the first exemplary embodiment;

FIG. 15 is a schematic diagram illustrating an example of a menu specifying screen displayed on a display section by performing post setting instruction processing according to the first exemplary embodiment;

FIG. 16 is a flow chart illustrating an example of flow of new group adding processing according to the first exemplary embodiment;

FIG. 17 is a schematic diagram illustrating an example of a group list screen according to a first exemplary embodiment;

FIG. 18 is a schematic diagram illustrating an example of a new group adding screen according to the first exemplary embodiment;

FIG. 19 is a flow chart illustrating an example of flow of provision processing after sorting included in data provision processing according to the first exemplary embodiment;

FIG. 20 is a schematic diagram illustrating an example of a group designation guidance screen displayed on a display section by performing provision processing after sorting according to the first exemplary embodiment;

FIG. 21 is a functional block diagram illustrating an example of main functions of a smart device according to the second exemplary embodiment;

FIG. 22 is a schematic diagram illustrating an example of a configuration of respective policy tables included in access control policy data according to the second exemplary embodiment;

FIG. 23 is a block diagram illustrating an example of main configuration of an electrical system of a smart device according to the second exemplary embodiment;

FIG. 24 is a flow chart illustrating an example of flow of processing at installation included in data provision processing according to the second exemplary embodiment;

FIG. 25 is a flow chart illustrating an example of flow of setting processing included in processing at installation according to the second exemplary embodiment;

FIG. 26 is a flow chart illustrating an example of flow of post setting instruction processing included in data provision processing according to the second exemplary embodiment;

FIG. 27 is a flow chart illustrating an example of flow of provision processing after sorting included in data provision processing according to the second exemplary embodiment;

FIG. 28 is a schematic diagram illustrating an example of a policy setting guidance screen displayed on a display section by performing provision processing after sorting according to the second exemplary embodiment;

FIG. 29 is a schematic diagram illustrating an example of a filter generated by performing provision processing after sorting according to the second exemplary embodiment;

FIG. 30 is a schematic diagram illustrating an example of a first permissibility data setting screen according to the second exemplary embodiment;

FIG. 31 is a schematic diagram illustrating an example of a second permissibility data setting screen according to the second exemplary embodiment;

FIG. 32 is a functional block diagram illustrating an example of main functions of a conventional smart device; and

FIG. 33 is a schematic diagram illustrating an example of a list of classifications of user data requested by an installed application on a conventional smart device.

### DESCRIPTION OF EMBODIMENTS

### Comparative Example

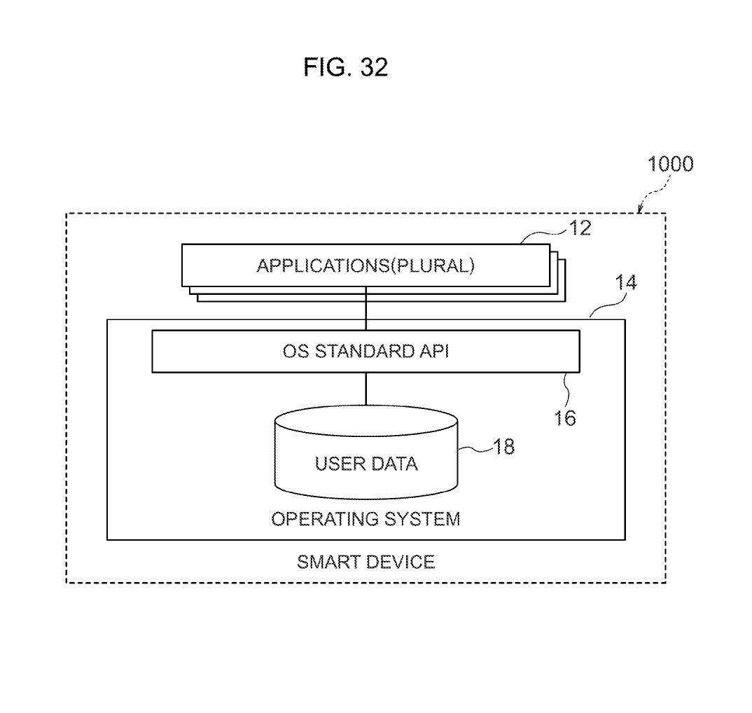

Prior to explaining an exemplary embodiment of technology disclosed herein, explanation first follows regarding a comparative example to the technology disclosed herein. As an example, a smart device 1000 illustrated in FIG. 32 includes plural applications 12 and an OS 14. The applications 12 are, for example, third party developed applications (called apps) that have been made public through an app market, and are downloadable via the internet.

The OS 14 includes an OS standard Application Programming Interface (API) 16 and user data 18. The OS standard API 16 is provided by the OS 14 as a standardized interface for applications 12. The user data 18 is private data relating to a user of the smart device 1000 (for example address book or schedule book), and is data stored in an internal memory of the smart device 1000.

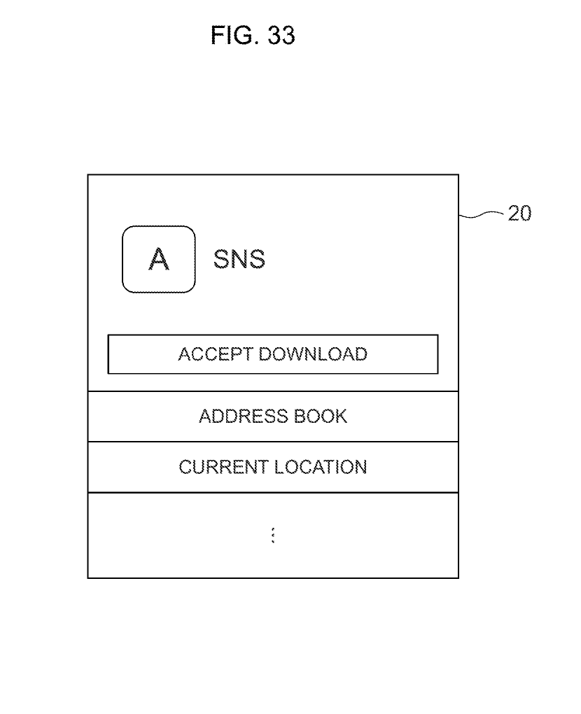

In the smart device 1000, sometimes when starting to download an application 12 under instruction of a user, the provision of the user data 18 is requested by the application 12 instructed for downloading. In such cases, the smart device 1000 displays a list 20, such as the example illustrated in FIG. 33, of classifications of user data 18 requested by the applications 12, on for example a touch panel display. The name of the application 12 instructed for download (“SNS” in the example illustrated in FIG. 33) and the classifications of the user data 18 (address book and current location in the example illustrated in FIG. 33) are displayed in the list 20 illustrated in FIG. 33. An accept button (a button displaying “accept download”) is displayed in the list 20. The smart device 1000 starts downloading and installing the application 12 instructed for download when the accept button is pressed.

The application 12 installed on the smart device 1000 requests provision of the user data 18 (the user data 18 illustrated in the list 20) through the OS standard API 16. Through the OS standard API 16, the OS 14 acquires the user data 18 in response to the request from the application 12, and provides the acquired user data 18 to the originally requesting application 12.

However, even if the application 12 installed on the smart device 1000 is for private use, in addition to the user data 18 for private use, it is also possible to acquire the user data 18 for business use. For example, when the applications 12 requests provision of a phone book, there is a concern that telephone numbers contained in the phone book other than the private use telephone numbers (for example business telephone numbers) might be provided to the application 12.

### First Exemplary Embodiment

Detailed explanation follows of an exemplary embodiment of technology disclosed herein, with reference to the drawings. Note that although in the following explanation is given of an example in which a smart device is an example of a terminal device, the technology disclosed herein is not limited thereto. The technology disclosed herein may, for example, be applied to various types of terminal devices that install and use applications, such as a personal computer, a game console, a car navigation device or a mobile phone. In the following explanation, the same reference numerals are used for similar portions to those of the Comparative Example, and further explanation thereof is omitted.

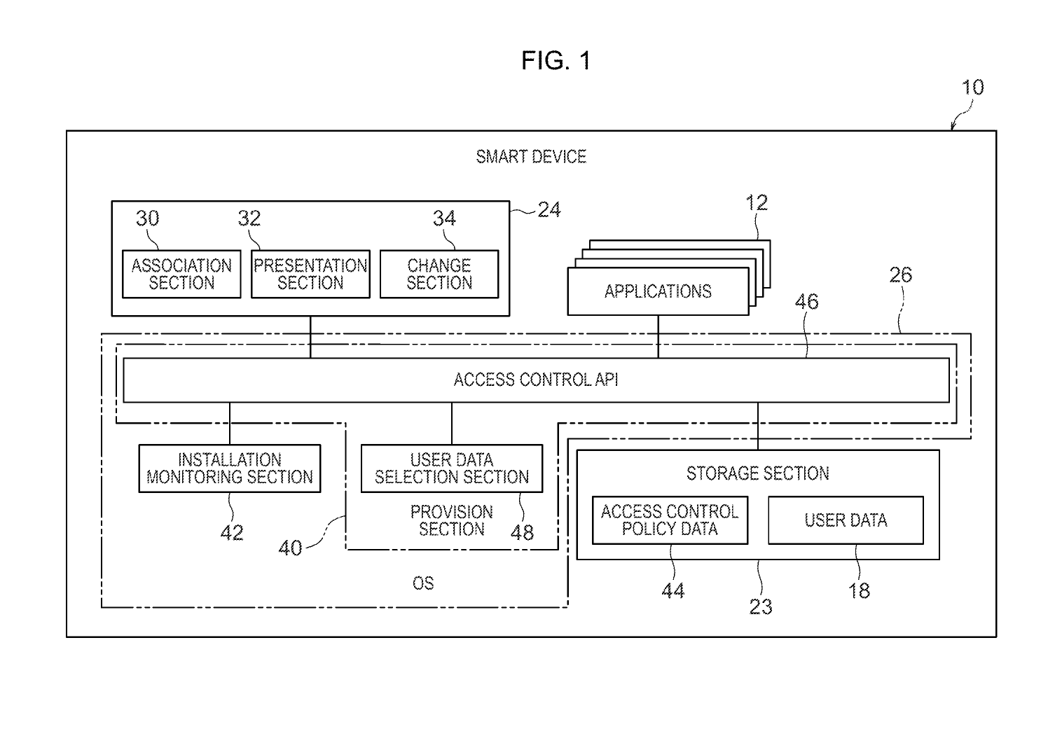

A smart device 10 illustrated as an example in FIG. 1 includes plural applications 12, a storage section 23, a policy setting section 24 and an OS 26.

The storage section 23 stores user data 18 (an example of data according to technology disclosed herein) and access control policy data 44 (described later). Permissibility data representing whether or not provision is permitted according to the access control policy data 44 is associated with each of the items of user data 18. Moreover, the user data 18 is classified into plural different usages. Note that in the following, for ease of explanation, permissibility data representing that provision of the user data 18 is not permitted is called “not permitted data”, and permissibility data representing that provision of the user data 18 is permitted is called “permitted data”.

The policy setting section 24 presents the user data 18, whose provision the installed application 12 is requesting, to a user in a selectable format, and sets a security policy according to user instructions. Setting of the security policy (referred to below as “policy setting”) means setting the provision permissibility of the user data 18 to the applications 12 (setting the permissibility data). Note that, for ease of explanation, explanation is given in the first exemplary embodiment of an example in which the policy setting section 24 is implemented by a software configuration, however there is no limitation thereto, and the policy setting section 24 may be implemented by a hardware configuration, or may be implemented by a combination of a software configuration and a hardware configuration.

The policy setting section 24 includes an association application section 30, a presentation section 32 and a change section 34. The association application section 30 applies associations between specific applications 12 that request provision of the user data 18 and prescribed usages prescribed from plural usages. The specific applications 12 here indicate, for example, the applications 12 that have been designated by a user as targets for associating with a group.

When a new application 12 is introduced (such as for example when it is installed), the presentation section 32 presents information prompting designation of usages to associate with the newly introduced application 12.

The change section 34 changes the contents of the permissibility data attached to the user data 18 according to a given instruction (for example an instruction from a user though a touch panel display).

The OS 26 includes a provision section 40 and an installation monitoring section 42. The provision section 40 provides to the application 12 that has requested provision of the user data 18 any user data 18 that has been appended with permitted data, out of the user data 18 of the designated usages associated by the association application section 30. The provision section 40 does not provide to the application 12 that has requested provision of the user data 18 any user data 18 that has been appended with not permitted data, out of the user data 18 of the designated usages associated by the association application section 30.

The provision section 40 includes an access control API 46 and a user data selection section 48. The access control API 46 receives requests from the applications 12 to provide the user data 18, acquires the access control policy data 44 and the user data 18, and provides the acquired access control policy data 44 and the user data 18 to the user data selection section 48. The user data 18 returned by the user data selection section 48 is then provided to the originally requesting application 12.

The user data selection section 48 sorts the user data 18 permitted for provision to the originally requesting application 12 and the user data 18 not permitted for provision based on the access control policy data 44 provided from the access control API 46. The user data 18 that is permitted for provision to the originally requesting application 12 is then returned to the access control API 46.

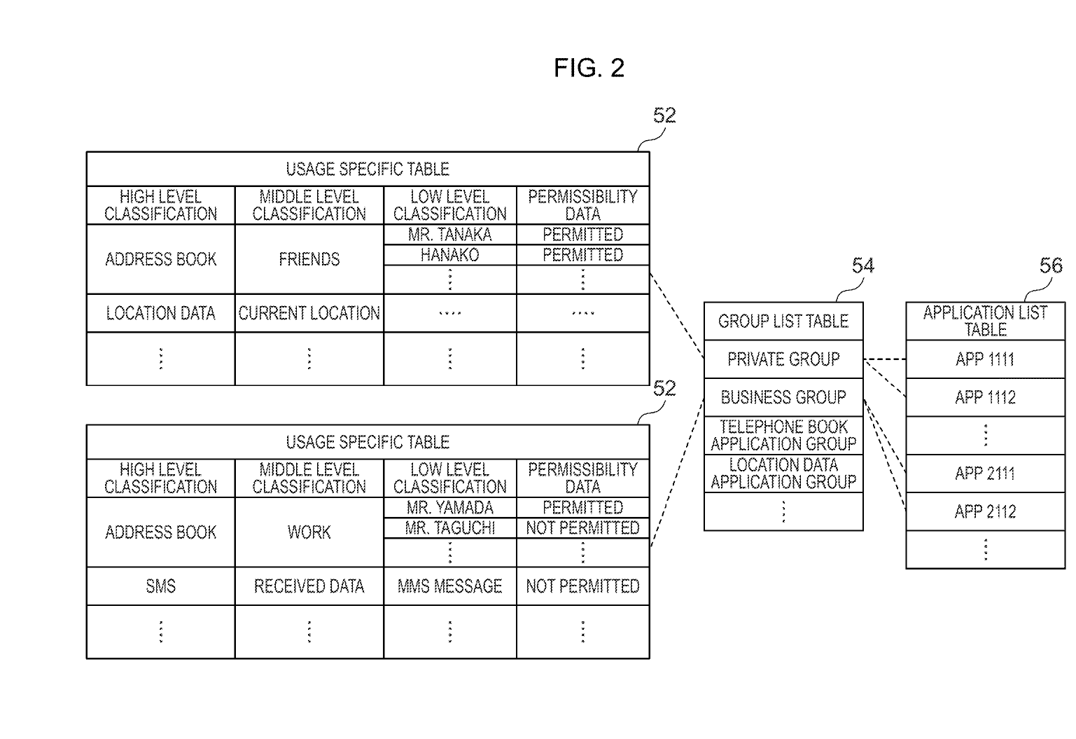

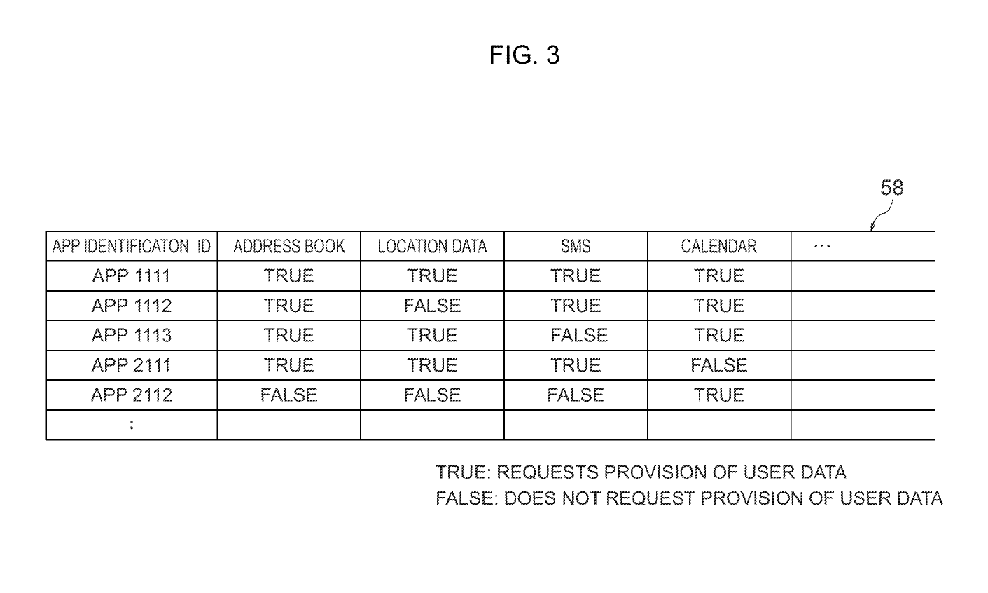

The access control policy data 44 includes a usage specific table 52, a group list table 54 and an application list table 56, for example as illustrated in FIG. 2, and a high level classification specification table 58, for example as illustrated in FIG. 3.

The usage specific table 52 illustrated as an example in FIG. 2 is a table in which classifications of user data 18 (referred to below simply as “classifications”) and permissibility data are associated with specific usages of the user data 18 (referred to below simply as “usages”). Classifications is made by hierarchical layers to which the user data 18 belongs, with classification into high level classifications, middle level classifications that are divisions of the high level classifications, and low level classifications that are divisions of the middle level classifications. In the example illustrated in FIG. 2, address book, location data and social message service (SMS) are high level classifications. Friends and work, belonging to the level below address book, current location (for example location data of the current position identified using GPS), belonging to the level below location data, and reception data (such as data that has been received using SMS), belonging to the level below SMS, are each middle level classifications. Individual names (such as “Mr. Tanaka”, “Hanako”, Mr. Yamada”, and “Mr. Taguchi”), belonging to the levels respectively below friends and work, and multimedia messaging service (MMS), belonging to the level below reception data, are each low level classifications.

Note that as usage in the first exemplary embodiment, usages that a user has designated in advance are employed, however there is no limitation thereto, and for example usage predetermined by default may be employed. Moreover, although in the first exemplary embodiment classifications that have been designated in advance by a user are allocated to each usage, there is no limitation thereto, and classifications may be allocated in advance to each of the usages by default.

The group list table 54 illustrated as an example in FIG. 2 is a table listing groups to which the user data 18 classified by specific usage belong, and for which the usage is uniquely identifiable. The groups contained in the group list table 54 are associated with usages in the usage specific table 52. In the example illustrated in FIG. 2, examples are given of a private group, a business group, a telephone book application group and a location data application group, and a usage specific table 52 to which the user data 18 for private use belongs is associated with the private group. A usage specific table 52 to which the user data 18 for business use belongs is associated with the business group. While omitted in the drawings, a usage specific table 52 to which the user data 18 for use in telephone book applications (for example applications to manage telephone numbers) belongs is associated with the telephone book application group. While omitted in the drawings, a usage specific table 52 to which the user data 18 for use in location data applications (for example applications related to navigation) belongs is associated with the location data application group.

The application list table 56 illustrated as an example in FIG. 2 is a table listing app identification IDs of the installed applications 12. The app identification IDs are unique IDs allocated to each of the applications 12.

The high level classification of the user data 18 that the applications 12 request to be provided is recorded for example in the high level classification specification table 58 illustrated in FIG. 3. The high level classification specification table 58 illustrated in FIG. 3 is a table capable of identifying for each of the app identification IDs high level classifications of the user data 18 that the application 12 requests to be provided and the user data 18 that the application 12 does not request to be provided. In the example illustrated in FIG. 3, true-false values are associated with the high level classification of the user data 18 for each of the app identification IDs. Namely, a true value is associated with high level classifications of user data 18 that the application 12 requests to be provided, and a false value is associated with high level classifications of the user data 18 that the application 12 does not request to be provided.

The installation monitoring section 42 monitors whether or not a new application 12 has been installed, and actuates the policy setting section 24 when determined that a new applications 12 has been installed.

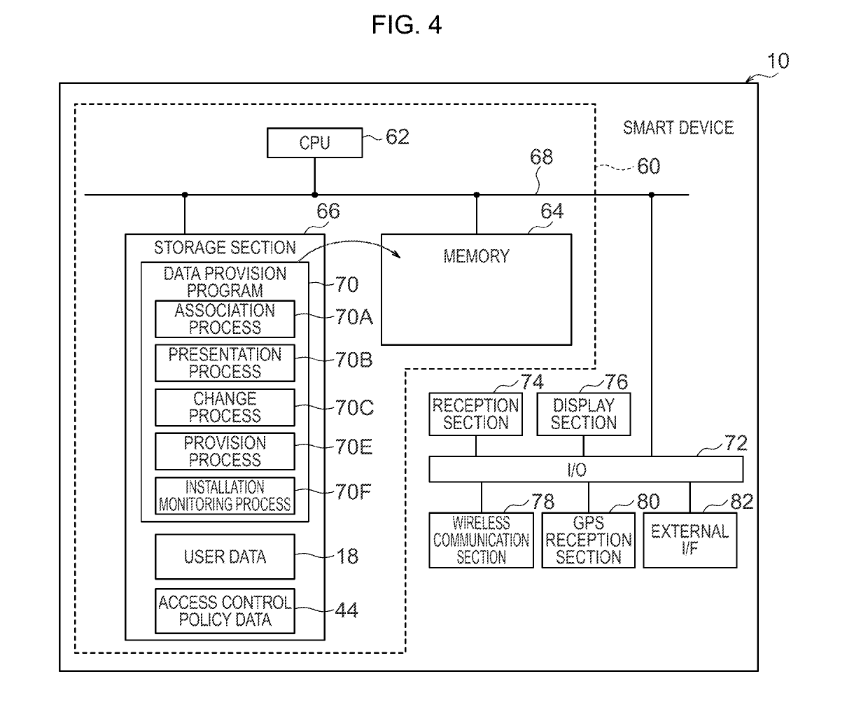

As illustrated in the example of FIG. 4, the smart device 10 includes a computer 60 and various input and output devices. The association application section 30, the presentation section 32, the change section 34 and the provision section 40 may for example be implemented by the computer 60 and the various input and output devices.

The computer 60 includes a Central Processing Unit (CPU) 62, a non-volatile memory 64 (for example Random Access Memory (RAM)) and a non-volatile storage section 66 that is an example of the storage section 23 illustrated in FIG. 1. A Hard Disk Drive (HDD) or flash memory may be employed as the storage section 66. The CPU 62, the memory 64 and the storage section 66 are connected together by a bus 68.

The user data 18, the access control policy data 44 and a data provision program 70 are stored in the storage section 66.

The CPU 62 reads the data provision program 70 from the storage section 66, expands the data provision program 70 into the memory 64, and sequentially executes processes of the data provision program 70. The data provision program 70 includes an association application process 70A, a presentation process 70B, a change process 70C, a provision process 70E and an installation monitoring process 70F.

The CPU 62 operates as the association application section 30 illustrated in FIG. 1 by executing the association application process 70A. The CPU 62 operates as the presentation section 32 illustrated in FIG. 1 by executing the presentation process 70B. The CPU 62 operates as the change section 34 illustrated in FIG. 1 by executing the change process 70C. The CPU 62 operates as the provision section 40 illustrated in FIG. 1 by executing the provision process 70E. Moreover, the CPU 62 operates as the installation monitoring section 42 illustrated in FIG. 1 by executing the installation monitoring process 70F.

Note that although an example is given here of a case in which the data provision program 70 is read from the storage section 66, the data provision program 70 does not always need to be initially stored on the storage section 66. For example, the data provision program 70 may first be stored on a chosen “portable storage medium” employed connected to the computer 60, such as a Solid State Drive (SSD), Digital Versatile Disk (DVD), IC card, magneto-optical disk or CD-ROM. The computer 60 may then acquire and execute the data provision program 70 from the portable storage medium. The data provision program 70 may also be stored on a storage section of another computer or server device connected to the computer 60 through a communications line. In such cases the computer 60 acquires and executes the data provision program 70 from the other computer or server device.

The smart device 10 includes an input-output interface (I/O) 72 that electrically connects the computer 60 and various input and output devices, and controls transmission and reception of various data between the computer 60 and various input and output devices. The smart device 10 includes a reception section 74, a display section 76, a wireless communication section 78, a GPS reception section 80 and an external interface (I/F) 82, as input-output devices that are electrically connected to the computer 60 through the bus 68 by connection to the I/O 72.

The reception section 74 includes a touch panel, and keys (hard keys) or the like provided outside the touch panel, and receives instructions from a user of the smart device 10. The display section 76 is a display superimposed with the touch panel, and displays various types of information.

The wireless communication section 78 controls transmission and reception of various data with a web server connected to the internet by performing wireless communication with a base station connected to the internet. The GPS reception section 80 receives radio waves from a GPS according to instructions from the computer 60. The external I/F 82 is connected to an external device (for example to a personal computer or USB memory) and controls transmission and reception of various data between external devices and the computer 60.

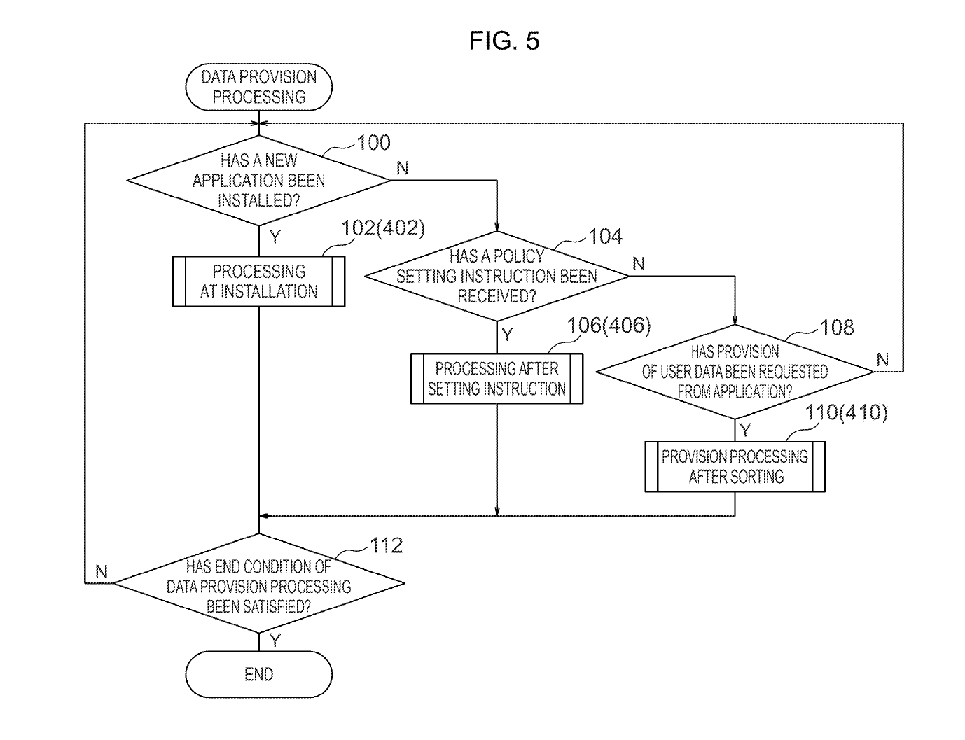

Explanation next follows regarding an example of flow of data provision processing performed by the smart device 10 as operation of the first exemplary embodiment, with reference to FIG. 5. Note that the data provision processing is implemented by the data provision program 70 stored in the storage section 66 being executed by the CPU 62.

In the data provision processing illustrated in FIG. 5, first, at step 100, determination is made by the installation monitoring section 42 as to whether or not a new application 12 has been installed. Affirmative determination is made at step 100 and processing proceeds to step 102 when a new application 12 has been installed. Negative determination is made at step 100 and processing proceeds to step 104 when a new application 12 has not been installed.

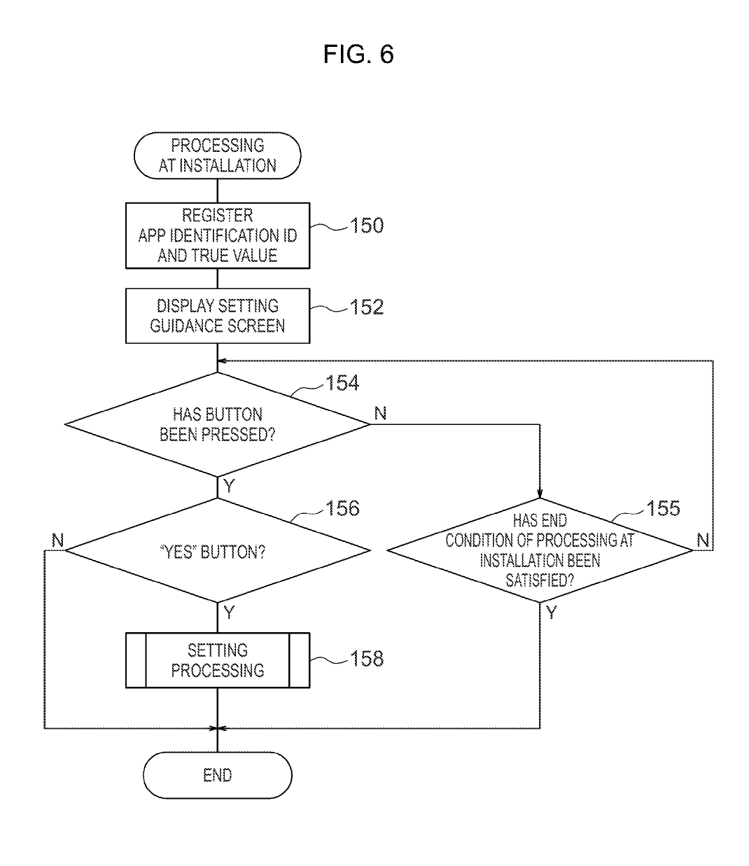

At step 102, processing at installation such as the example illustrated in FIG. 6 is performed by the policy setting section 24, and then processing proceeds to step 112.

At step 104, determination is made by the presentation section 32 as to whether or not a policy setting instruction has been received by the reception section 74. Affirmative determination is made at step 104 and processing proceeds to step 106 when the reception section 74 has received a policy setting instruction. Negative determination is made at step 104 and processing proceeds to step 108 when the reception section 74 has not received a policy setting instruction.

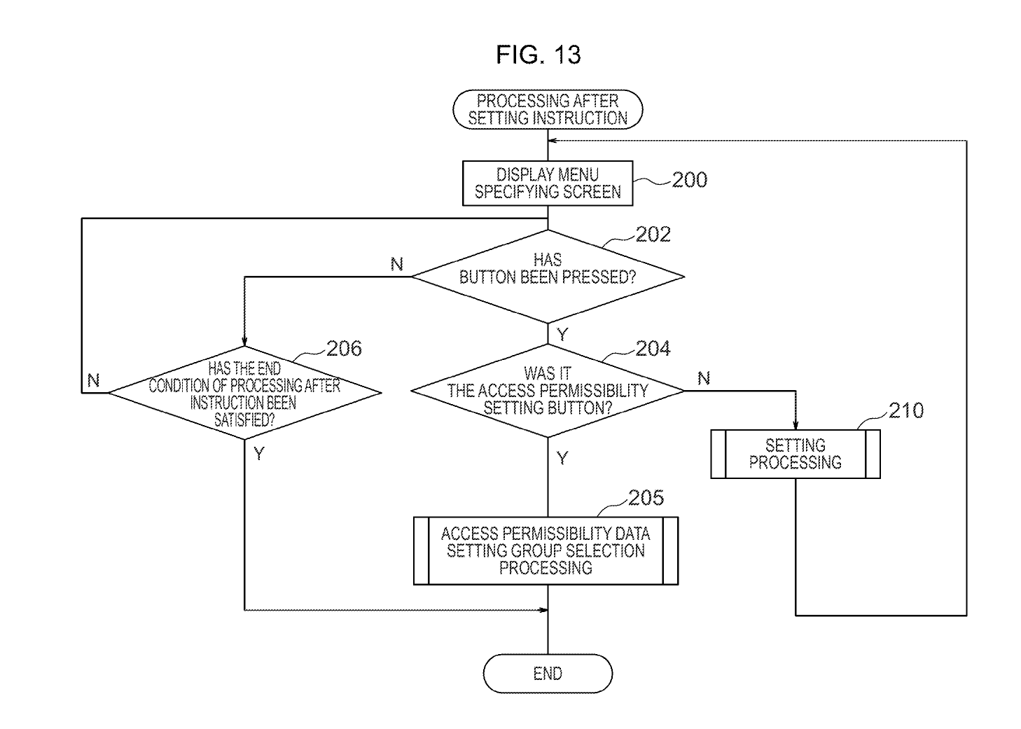

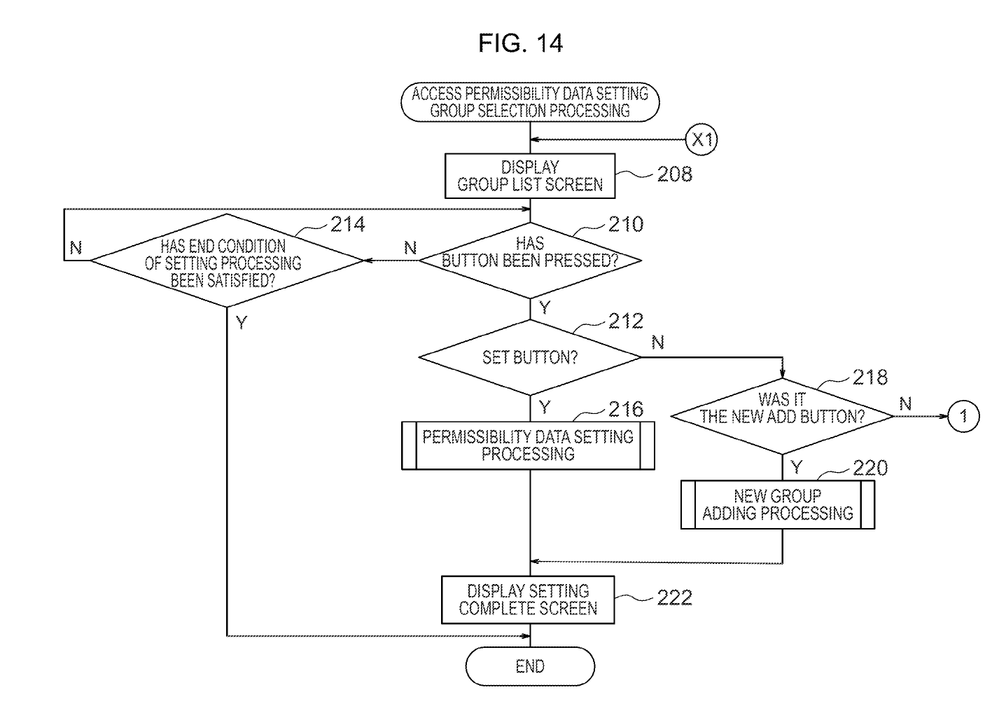

At step 106, post setting instruction processing such as the example illustrated in FIG. 13 and FIG. 14 is performed by the policy setting section 24, then processing proceeds to step 112.

At step 108, determination is made by the provision section 40 as to whether or not there is a request for provision of the user data 18 from already an installed application 12. Affirmative determination is made at step 108 and processing proceeds to step 110 when there is a request for provision of the user data 18 from the already installed application 12. Negative determination is made at step 108 and processing returns to step 100 when there is no request for provision of the user data 18 from the already installed application 12. Note that for example launching of the application 12 is an example of a case in which there is a request from the application 12 for provision of the user data 18.

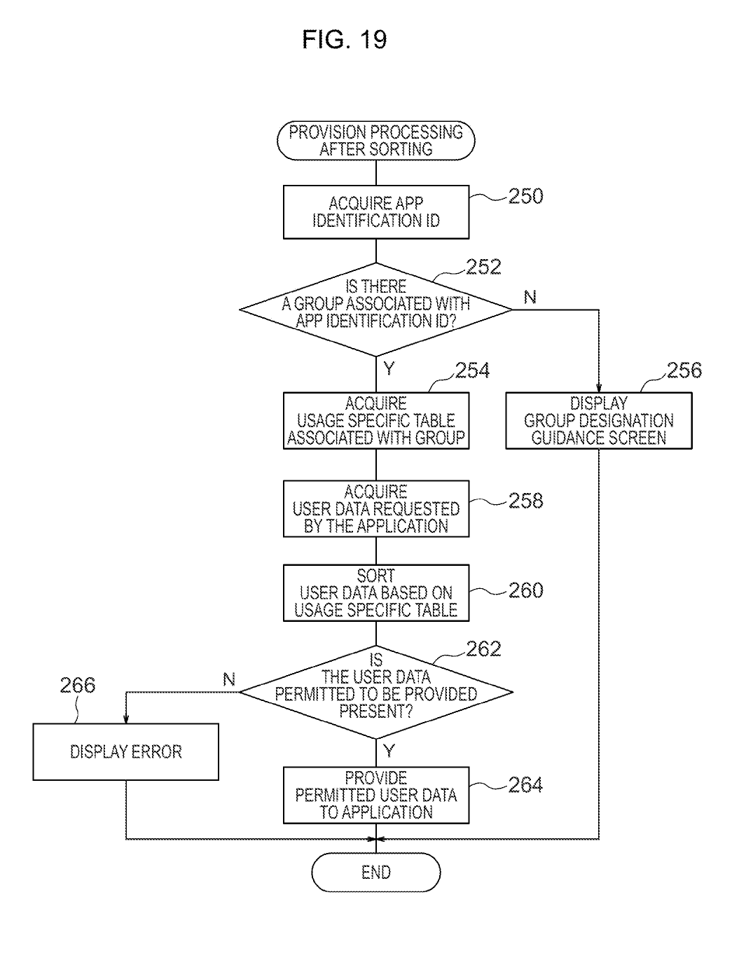

At step 110, post screening provision processing as illustrated in the example in FIG. 19 is performed by the provision section 40, and then processing proceeds to step 112.

At step 112, determination is made as to whether or not a condition to end data provision processing (data provision processing end condition) is satisfied. Reference here to the data provision processing end condition means, for example, a condition that the reception section 74 has received an instruction to end data provision processing, a condition that the reception section 74 has received a non-execution instruction (an instruction not to perform data provision processing for the smart device 10). Negative determination is made at step 112 and processing returns to step 100 when the data provision processing end condition is not satisfied. Affirmative determination is made at step 112 when the data provision processing end condition is satisfied, and the data provision processing is ended.

In an example of processing at installation as illustrated in FIG. 6, first at step 150, the presentation section 32 registers an app identification ID related to the newly installed application 12 in the application list table 56 and the high level classification specification table 58. Then the presentation section 32 registers a true value in the high level classification specification table 58 for each of the high level classifications. It is thereby possible to manage, for each of the applications 12, the high level classification of any user data 18 requested for provision by the newly installed application 12, and the high level classification of any user data 18 not requested for provision.

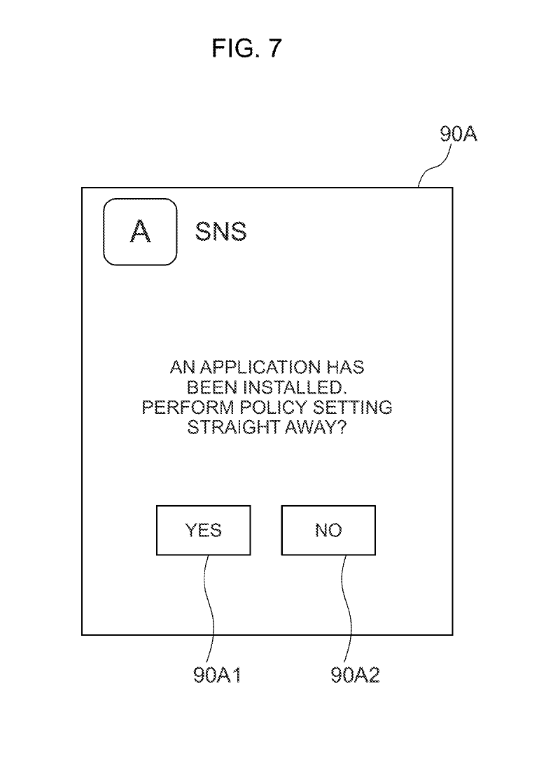

Next at step 152 the presentation section 32 displays on the display section 76 a setting guidance screen 90A that prompts the user to set the policy that applies to any user data 18 that the installed application 12 requests provision of, as illustrated in the example of FIG. 7. In the example illustrated in FIG. 7, a message is displayed on the setting guidance screen 90A informing of the installation of a new application 12 and asking a user whether or not to perform policy setting straight away. The setting guidance screen 90A is displayed with a “Yes” button 90A1 to be pressed when policy setting is to be performed straight away, and a “No” button 90A2 to be pressed when policy setting is not to be performed straight away.

At the next step 154, the presentation section 32 determines whether or not the “Yes” button 90A1 or the “No” button 90A2 has been pressed. Affirmative determination is made at step 154 when the “Yes” button 90A1 or the “No” button 90A2 has been pressed, and processing proceeds to step 156. Negative determination is made at step 154 when neither the “Yes” button 90A1 nor the “No” button 90A2 has been pressed, and processing proceeds to step 155.

At step 155, the presentation section 32 determines whether or not a condition to end processing at installation (processing at installation end condition) has been satisfied. Reference here to an processing at installation end condition means for example a condition that the reception section 74 has received an instruction to end processing at installation, or a condition that a specific period of time (for example 1 minute) has elapsed since the setting guidance screen 90A was displayed. Negative determination is made at step 155 when the processing at installation end condition has not been satisfied, and processing returns to step 154. However affirmative determination is made at step 155 when the processing at installation end condition has been satisfied and the processing at installation is ended.

At step 156, the presentation section 32 determines whether or not the “Yes” button 90A1 has been pressed at step 154. Negative determination is made at step 156 when the “Yes” button 90A1 has not been pressed (when the “No” button 90A2 has been pressed) at step 154, and the processing at installation is ended. Affirmative determination is made at step 156 when at step 154 the “Yes” button 90A1 has been pressed and processing proceeds to step 158.

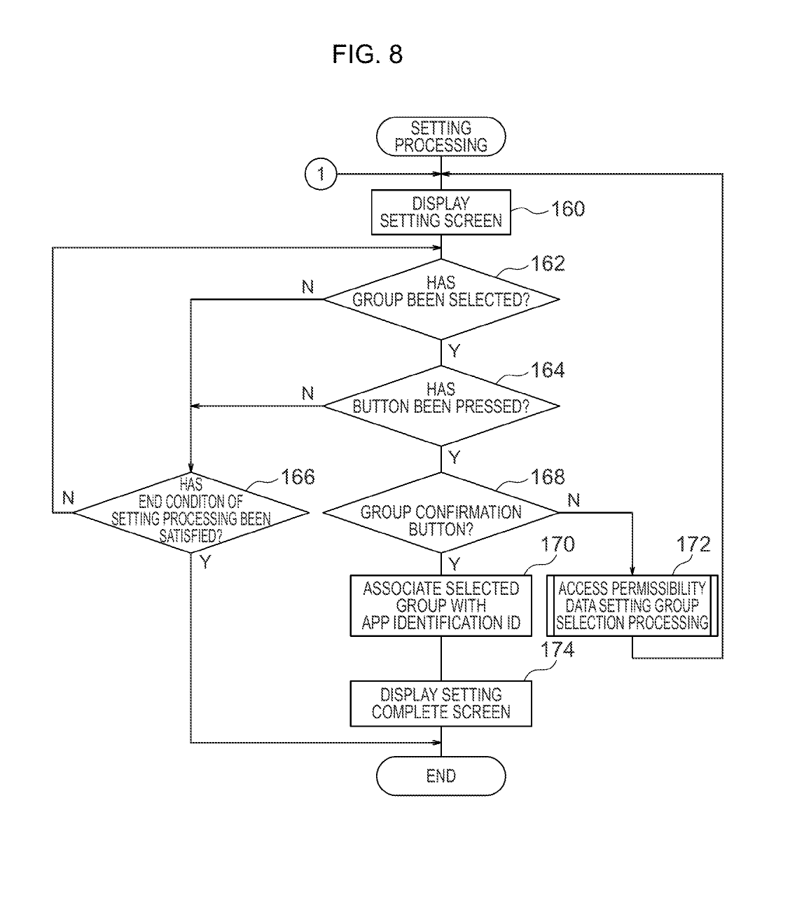

At step 158, the presentation section 32 performs setting processing such as the example illustrated in FIG. 8, and then ends the processing at installation.

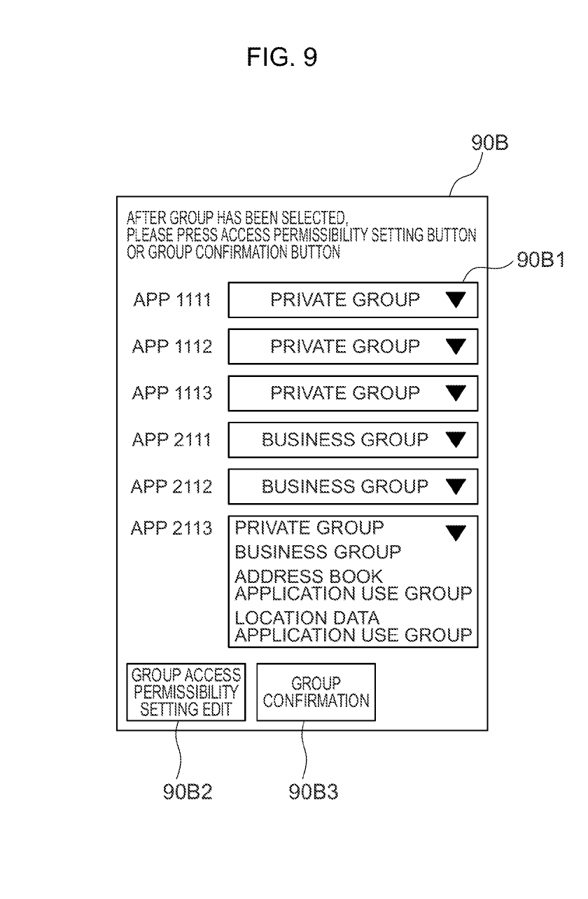

In the setting processing illustrated in FIG. 8, first at step 160, the presentation section 32 displays on the display section 76 a setting screen 90B (an example of “information prompting group indication” of technology disclosed herein) for performing policy setting such the example illustrated in FIG. 9. In the setting screen 90B, a pull-down menu box 90B1 is displayed for each of the already installed applications 12. The pull-down menu displayed by the pull-down box 90B1 includes each of the groups registered in the group list table 54, and a user uses the reception section 74 to select any one group for one of the applications 12. When the group is selected thus, applications 12 are displayed so as to be uniquely selectable adjacent to the pull-down box 90B1 including the pull-down menu displayed for the selected group. The names of the installed applications 12 may also be displayed with emphasis.

A group access permissibility setting editing button 90B2 and a group confirmation button 90B3 are displayed on the setting screen 90B. After selecting a group on the setting screen 90B, a message is displayed prompting a user to press the group access permissibility setting editing button 90B2 or the group confirmation button 90B3. The group access permissibility setting editing button 90B2 is a button to press to perform setting of the access permissibility for the user data 18 belonging to each of the groups registered in the group list table 54 (to change the contents of the permissibility data). The group confirmation button 90B3 is a button to press to confirm the group selected from the pull-down menu to be associated with the selected application 12.

Next at step 162, the association application section 30 determines whether or not any group has been selected using the setting screen 90B. Affirmative determination is made when at step 162 any of the groups has been selected using the setting screen 90B, and processing proceeds to step 164. Negative determination is made at step 162 when none of the groups has been selected by the setting screen 90B, and processing proceeds to step 166.

At step 166, the association application section 30 determines whether or not a condition to end setting processing (a setting processing end condition) has been satisfied. Reference here to the setting processing end conditions means for example a condition that an instruction to end setting processing has been received by the reception section 74, or a condition that a specific period of time (for example 1 minute) has elapsed since displaying the setting screen 90B. Affirmative determination is made at step 166 when the setting processing end condition is satisfied, and the setting processing is ended. Negative determination is made at step 166 when the setting processing end condition is not satisfied and processing returns to step 162.

At step 164, the association application section 30 determines whether or not the group access permissibility setting editing button 90B2 or the group confirmation button 90B3 has been pressed. Negative determination is made at step 164 and processing proceeds to step 166 when neither the group access permissibility setting editing button 90B2 nor the group confirmation button 90B3 has been pressed. Affirmative determination is made at step 164 and processing proceeds to step 168 when the group access permissibility setting editing button 90B2 or the group confirmation button 90B3 has been pressed.

At step 168, the association application section 30 determines whether or not group confirmation button 90B3 has been pressed at step 164. Affirmative determination is made at step 168 when the group confirmation button 90B3 has been pressed, and processing proceeds to step 170. Negative determination is made at step 168 when the group confirmation button 90B3 has not been pressed (when the group access permissibility setting editing button 90B2 has been pressed), and processing proceeds to step 172, where for example access permissibility data setting group selection processing such as that illustrated in FIG. 14 is performed by the association application section 30. Then in the current setting processing the association application section 30 ends the access permissibility data setting group selection processing and processing returns to step 160.

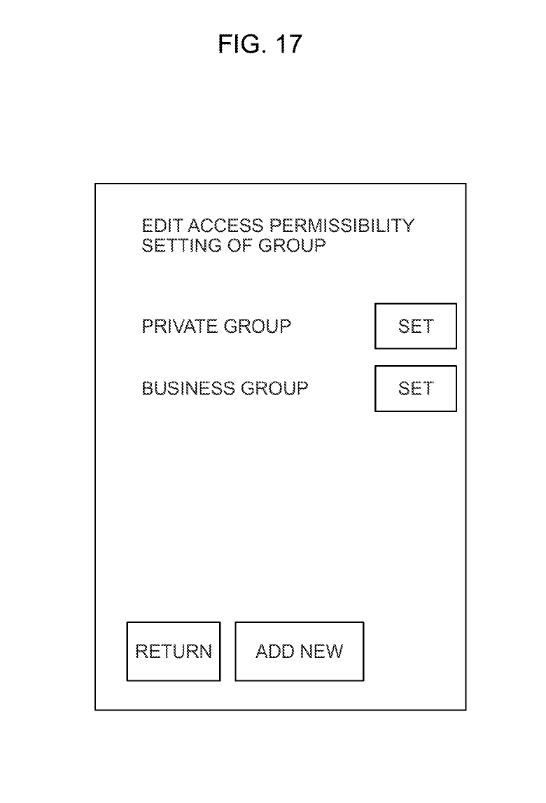

In the access permissibility data setting group selection processing illustrated in FIG. 14, first at step 208 the association application section 30 displays a group list screen such as the example illustrated in FIG. 17. The group list screen illustrated in FIG. 17 displays a group list. Set buttons are also displayed adjacent to the group list. A new add button and a return button are displayed on the group list screen.

Next at step 210, the association application section 30 determines whether or not any of the buttons displayed on the group list screen have been pressed. Affirmative determination is made at step 210 and processing proceeds to step 212 when any of the buttons displayed on the group list screen have been pressed. Negative determination is made at step 210 and processing proceeds to step 214 when none of the buttons displayed on the group list screen has been pressed.

At step 214, the association application section 30 determines whether or not the setting processing end condition has been satisfied. Negative determination is made at step 214 and processing returns to step 210 when the setting processing end condition has not been satisfied. Affirmative determination is made at step 214 when the setting processing end condition has been satisfied, and the access permissibility data setting group selection processing is ended.

At step 212, the association application section 30 determines whether or not the pressed button is a set button. Affirmative determination is made at step 212 when the pressed button is a set button, and processing proceeds to step 216. Negative determination is made at step 212 when the pressed button is not a set button and processing proceeds to step 218.

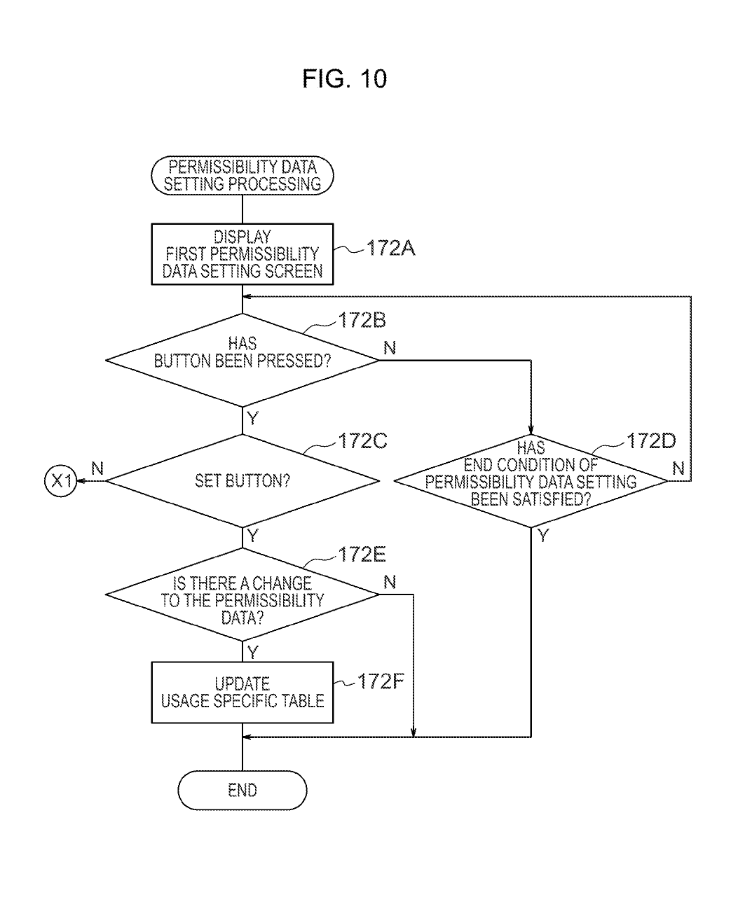

At step 216, the association application section 30 performs permissibility data setting processing such as the example illustrated in FIG. 10, and then processing proceeds to step 222.

At step 218, the association application section 30 determines whether or not the pressed button is the new add button. Affirmative determination is made at step 218 when the pressed button is the new add button, and processing proceeds to step 220. Negative determination is made at step 218 when the pressed button is not the new add button (when the return button is pressed), and processing returns to step 160 illustrated in FIG. 8.

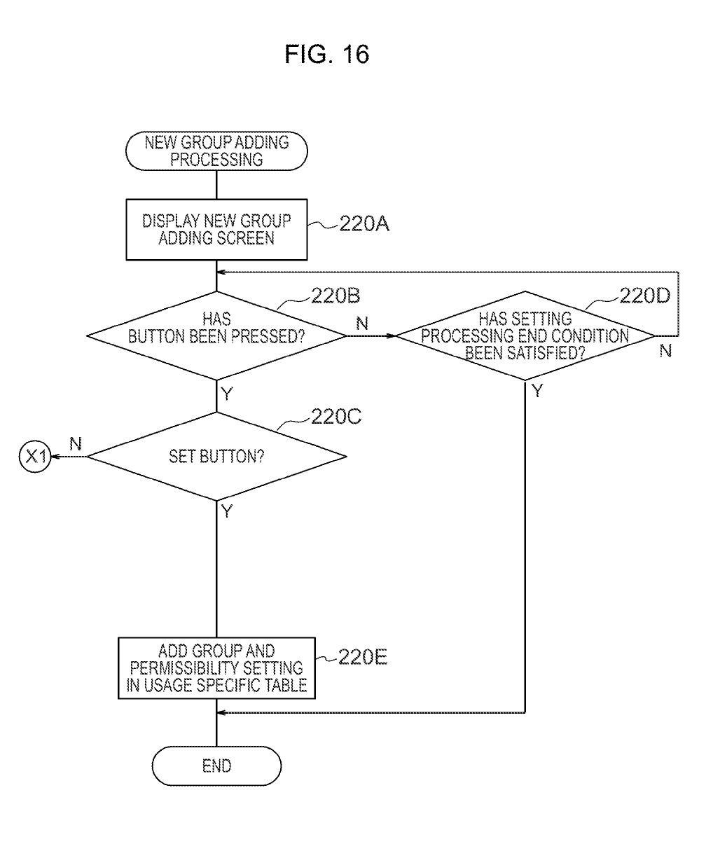

At step 220, the association application section 30 performs new group adding processing such as the example illustrated in FIG. 16, and then processing proceeds to step 222.

At step 222, the association application section 30 displays a setting complete screen 90D and ends access permissibility data setting group selection processing.

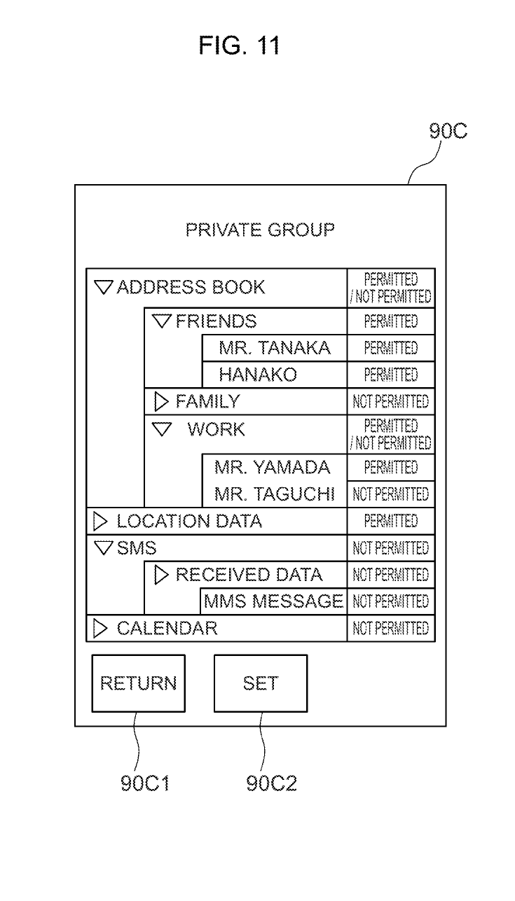

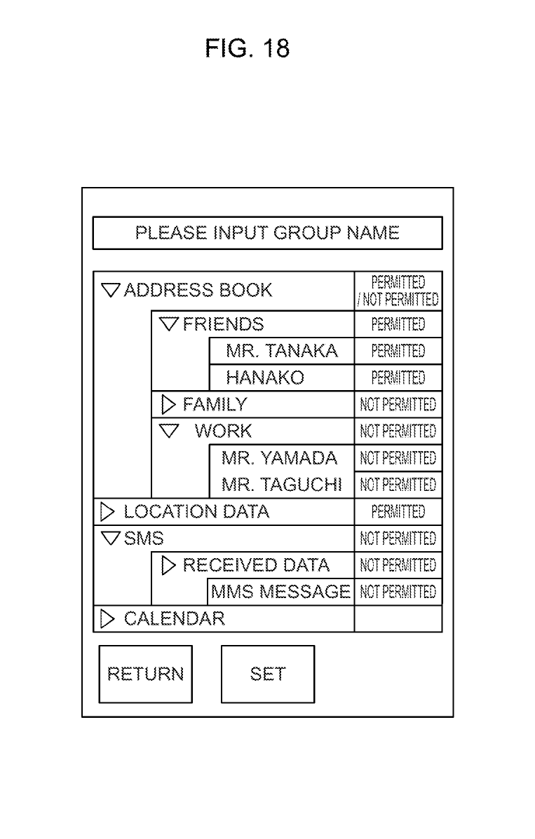

In the new group adding processing illustrated in FIG. 16, first at step 220A, the association application section 30 displays a new group adding screen such as the example illustrated in FIG. 18. The new group adding screen illustrated in FIG. 18 differs from a first permissibility data setting screen 90C illustrated in FIG. 11 in that a group name input column is provided. A new group name is input in the group name input column according to user instruction.

Next at step 220B, the association application section 30 determines whether or not one of the buttons displayed on the new group adding screen has been pressed. Affirmative determination is made at step 220B when one of the buttons displayed on the new group adding screen has been pressed, and processing proceeds to step 220C. Negative determination is made at step 220B when none of the buttons displayed on the new group adding screen has been pressed, and processing proceeds to step 220D.

At step 220D, the association application section 30 determines whether or not the setting processing end condition has been satisfied. Affirmative determination is made at step 220D when the setting processing end condition has been satisfied, and the new group adding processing is ended. Negative determination is made at step 220D when the setting processing end condition has not been satisfied and processing returns to step 220B.

At step 220C, the association application section 30 determines whether or not the pressed button is the set button. Affirmative determination is made at step 220C when the pressed button is the set button and processing proceeds to step 220E. Negative determination is made at step 220C when the pressed button is not the set button (when the return button has been pressed) and processing proceeds to step 208 illustrated in FIG. 14.

At step 220E, the association application section 30 adds and sets a new additional group to the usage specific table 52 and the group list table 54 (for example associates together a new usage specific table 52 and a new additional group) according to the display contents on the new group adding screen. Moreover, the association application section 30 sets permissibility data for the corresponding usage specific table 52 according to the display contents of the new group adding screen (for example sets the permissibility data in a usage specific table 52 that has been newly added), and then ends the new group adding processing.

In the permissibility data setting processing illustrated in FIG. 10, first at step 172A, the presentation section 32 displays on the display section 76 the first permissibility data setting screen 90C for setting permissibility data, such as the example illustrated in FIG. 11. The contents of the usage specific table 52 illustrated as an example in FIG. 2 is displayed on the first permissibility data setting screen 90C. In the example illustrated in FIG. 11, a situation is illustrated of the first permissibility data setting screen 90C when a private group is selected on the setting screen 90B. In the first permissibility data setting screen 90C, the type of the group associated with the usage specific table 52 (“private group” in the example illustrated in FIG. 11) is displayed so as to be specifiable.

Moreover, in the first permissibility data setting screen 90C, contents of permissibility data appended to each of the high level classification, middle level classification and low level classification are displayed by classification unit. For example, in cases in which permissibility data is appended to all the user data 18 belonging to the high level classification, text of “permitted” is displayed adjacent to the name of the high level classification. Or, in cases in which not permitted data is appended to all of the user data 18 belonging to the high level classification, text of “not permitted” is displayed adjacent to the name of the high level classification. However, in cases in which there is a mixture of user data 18 appended with permissibility data and user data 18 appended with not permitted is present in the high level classification, then text of “permitted/not permitted” is displayed adjacent to the name of the high level classification.

In the first permissibility data setting screen 90C, pull-down buttons are displayed in the respective columns for each of the classifications, and when a pull-down button included in the column of the high level classification is pressed, the middle level classifications belonging to the level below the high level classification whose pull-down button has been pressed are displayed in pull-down. Then, similarly to with the high level classification, text for “permitted”, “not permitted” and “permitted/not permitted” are displayed adjacent to the middle level classifications.

When a pull-down button included in the column of the middle level classification is pressed, the low level classifications belonging to the level below the middle level classification whose pull-down button has been pressed are displayed in pull-down. In cases in which permitted data has been appended to the user data 18 belonging to the low level classification then the text of “permitted” is displayed adjacent to the name of the low level classification. Moreover, when not permitted data is appended to the user data 18 belonging to the low level classification, text of “not permitted” is displayed adjacent to the name of the low level classification.

Note that the example illustrated in FIG. 11 illustrates a situation in which the contents of permissibility data is displayed for each of the classifications in a pull-down format in response to a user instruction through the reception section 74, however there is no limit thereto, and the contents of permissibility data may be displayed for all the classifications on initial display.

When the first permissibility data setting screen 90C is displayed on the display section 76, the display contents of the permissibility data appended to each of the classifications is changed according to instructions from a user through the reception section 74. For example, text for “permitted/not permitted”, “permitted” and “not permitted” displayed adjacent to each of the names of the high level classification is switched over according to instruction from a user through the reception section 74. For example, when there is detection of contact by an instruction body (for example a finger) at a position corresponding to the position where “permitted/not permitted” or “permitted” is displayed using a touch panel, a change is made from the “permitted/not permitted” or “permitted” to “not permitted”. Moreover, when there is detection of contact by an instruction body at a position corresponding to the position where “not permitted” is displayed using a touch panel, a change is made from the “not permitted” to “permitted”. Accompanying this, the display contents of all of the permissibility data appended to the middle level classifications and the low level classifications belonging to the levels below the high level classification are switched to display contents the same as the display contents of the permissibility data appended to the high level classification.

Moreover, similarly, the text of “permitted/not permitted”, “permitted” or “not permitted” displayed adjacent to the names of the middle level classifications are switched over according instructions from a user through the reception section 74. When the text of “permitted/not permitted”, “permitted” or “not permitted” displayed adjacent to the names of the middle level classification are switched over to “permitted” or “not permitted”, then accompanying this, the display contents of all of the permissibility data appended to the low level classifications belonging to the level below the middle level classification are switched to display contents the same as the display contents of the permissibility data appended to the middle level classification.

Moreover, text for “permitted” or “not permitted” is displayed adjacent to the name of the low level classifications, and are switched alternately according to a user instruction through the reception section 74. For example, “permitted” is changed to “not permitted” when there is detection of contact by an instruction body at a position corresponding to the position where “permitted” is displayed using a touch panel. Moreover, “not permitted” is changed to “permitted” when there is detection of contact by an instruction body at a position corresponding to the position where “not permitted” is displayed using a touch panel.

A return button 90C 1 and a set button 90C2 are displayed on the first permissibility data setting screen 90C. At the next step 172B, the change section 34 determines whether or not the return button 90C1 or the set button 90C2 has been pressed. Affirmative determination is made at step 172B when the return button 90C1 or the set button 90C2 has been pressed, and processing proceeds to step 172C. Negative determination is made at step 172B when the return button 90C1 or the set button 90C2 has been pressed, and processing proceeds to step 172D.

At step 172D, the change section 34 determines whether or not a condition to end the permissibility data setting processing (a permissibility data setting end condition) has been satisfied. Reference here to the permissibility data setting end condition refers to the condition that the reception section 74 has received an instruction to end the permissibility data setting processing, or a condition that a specific duration (for example 1 minute) has elapsed since the first permissibility data setting screen 90C was displayed. Negative determination is made at step 172D when the permissibility data setting end condition has not been satisfied, and processing returns to step 172B. Affirmative determination is made at step 170D when the permissibility data setting end condition has been satisfied and the permissibility data setting processing is ended.

At step 172C, the change section 34 determines whether or not the set button 90C2 was pressed at step 172B. Affirmative determination is made at step 172C and processing proceeds to step 172E when the set button 90C2 was pressed at step 172B. Negative determination is made at step 172C when the return button 90C1 was pressed at step 172B, and processing proceeds to step 208 as illustrated in FIG. 14.

At step 172E, the change section 34 determines whether or not there is a change in the display content of the permissibility data on the first permissibility data setting screen 90C displayed at step 172A. Negative determination is made at step 172E when there is no change in the display content of permissibility data in the first permissibility data setting screen 90C displayed at step 172A, and the permissibility data setting processing is ended. Affirmative determination is made at step 172E when there is a change in the display content of permissibility data in the first permissibility data setting screen 90C displayed at step 172A, and processing proceeds to step 172F.

At step 172F, the change section 34 updates the contents of permissibility data of the usage specific table 52 belonging to the group selected at step 162, by replacing with contents corresponding to the display content of permissibility data of the first permissibility data setting screen 90C currently displayed. The permissibility data setting processing is then ended after the processing of step 172F has been performed.

Returning to FIG. 8, at step 170, the association application section 30 associates the group selected at step 162 with the app identification ID of the installed application 12.

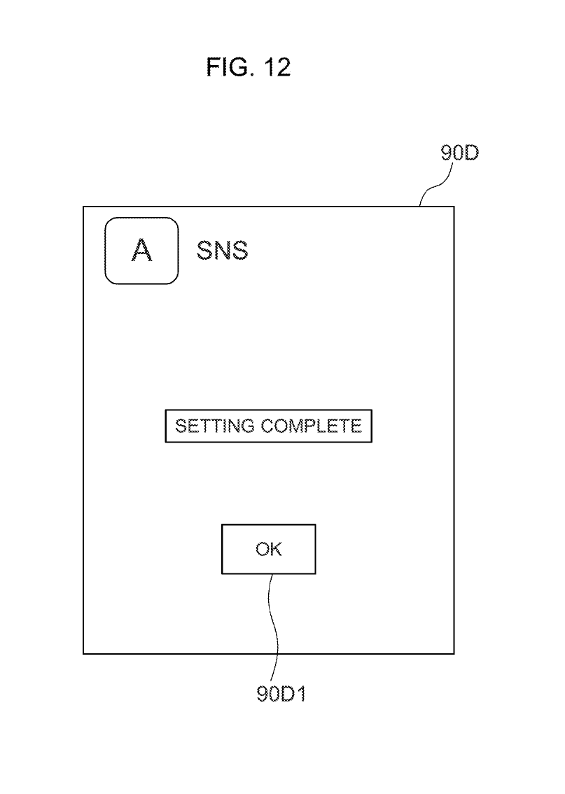

At the next step 174, the presentation section 32 displays on the display section 76 the setting complete screen 90D indicating that the policy setting has been completed, such as the example illustrated in FIG. 12, then ends the processing at installation. The example illustrated in FIG. 12 illustrates a manner in which a message “setting has been completed” and an OK button 90D1 are displayed on the setting complete screen 90D. The setting complete screen 90D ceases to be displayed and the home screen is displayed when the OK button 90D1 is pressed.

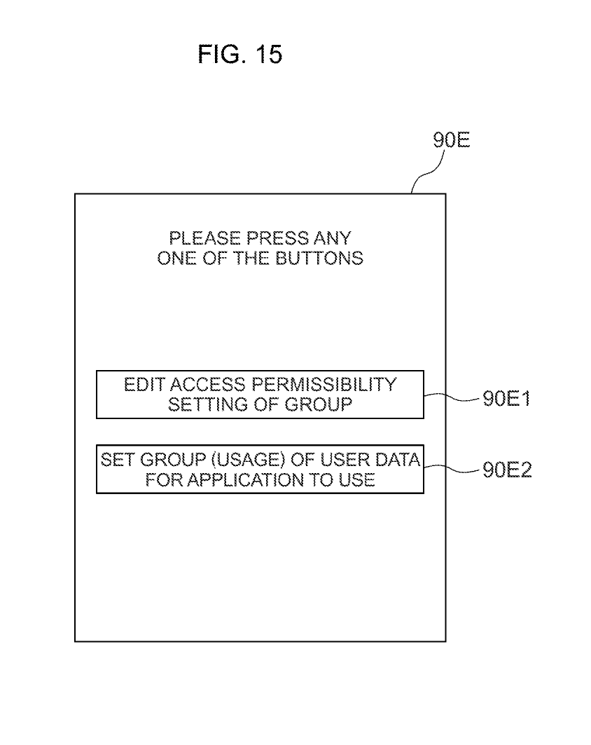

In setting specification post processing as illustrated in FIG. 13, first at step 200, the presentation section 32 displays on the display section 76 a menu specifying screen 90E for specifying a setting menu, such as the example illustrated in FIG. 15, then processing proceeds to step 202. An access permissibility setting button 90E1 and a group specifying button 90E2 is displayed on the menu specifying screen 90E, together with a message prompting pressing of one of the buttons. The access permissibility setting button 90E1 is a button to be pressed when setting whether or not to permit access to the user data 18 in the respective usage specific table 52 that each of the groups registered in the group list table 54 belongs to (when performing setting to relate each of the classifications to contents of permissibility data). The group specifying button 90E2 is a button that is pressed to associate applications 12 with groups, by specifying a group (usage) of the user data 18 to be used by the specific application 12.

At step 202, the change section 34 determines whether or not the access permissibility setting button 90E1 or the group specifying button 90E2 has been pressed. Affirmative determination is made at step 202 when the access permissibility setting button 90E1 or the group specifying button 90E2 has been pressed, and processing proceeds to step 204. Negative determination is made at step 202 when neither the access permissibility setting button 90E1 nor the group specifying button 90E2 have been pressed, and processing proceeds to step 206.

At step 206, the change section 34 determines whether or not a condition to end the setting specification post processing (specification post processing end condition) has been satisfied. The specification post processing end condition referred to means a condition that the reception section 74 has received an instruction to end the setting specification post processing, or a condition that a specific duration (for example 1 minute) has elapsed from when the menu specifying screen 90E was displayed. Affirmative determination is made at step 206 when the specification post processing end condition has been satisfied, and the setting specification post processing is ended. Negative determination is made at step 206 when the specification post processing end condition has not been satisfied, and processing proceeds to step 202.

At step 204, the change section 34 determines whether or not the access permissibility setting button 90E1 has been pressed at step 202. At step 204, affirmative determination is made at step 202 when the access permissibility setting button 90E1 has been pressed, and processing proceeds to step 205, where access permissibility data setting group selection processing such as the example illustrated in FIG. 14 is performed. Note that in this case, in the access permissibility data setting group selection processing, processing proceeds to step 200 when determined that the return button has been pressed at step 218 (when negative determination is made at step 218).

Negative determination is made at step 204 when the group specifying button 90E2 has been pressed at step 202, and processing proceeds to step 210.

At step 210, similarly to at step 158, the presentation section 32 performs setting processing as illustrated in the example of FIG. 8, and then processing returns to step 200.

In provision processing after sorting illustrated in FIG. 19, first at step 250 the provision section 40 acquires the app identification ID of the application 12 that requested provision of the user data 18 at step 108 illustrated in FIG. 5.

At the next step 252, the provision section 40 determines whether or not the group associated with the app identification ID acquired at step 250 is present in the group list table 54. Affirmative determination is made at step 252 when the group associated with the app identification ID acquired at step 250 is present in the group list table 54, and processing proceeds to step 254. Negative determination is made at step 252 when the group associated with the app identification ID acquired at step 250 is not present in the group list table 54, and processing proceeds to step 256.

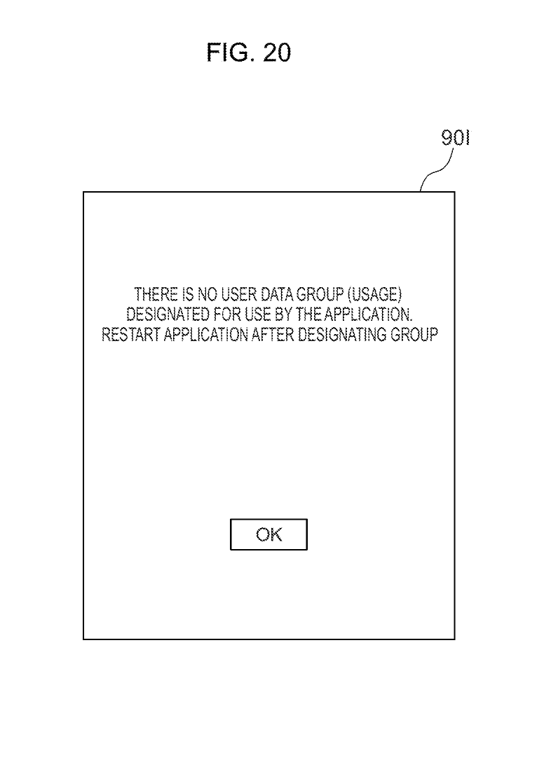

At step 256, the presentation section 32 displays a group designation guidance screen 901 such as the example illustrated in FIG. 20, and then ends the provision processing after sorting. Note that the group designation guidance screen 901 is a screen that works as a warning to prompt a user to restart the application 12 after designating the group (usage) of the user data 18 to be used by the application 12.

After the provision section 40 has acquired at step 254 the usage specific table 52 associated with the group corresponding to the app identification ID acquired at step 250, processing then proceeds to step 258.

At step 258, the provision section 40 acquires the user data 18 that was requested by the application 12, that requested provision of the user data 18 at step 108 illustrated in FIG. 5. Reference to the user data 18 to be acquired by the provision section 40 means, for example, the user data 18 belonging to any high level classifications for which a true value is associated in the high level classification specification table 58.

At the next step 260, the provision section 40 sorts the user data 18 based on the usage specific table 52 acquired at step 254 out of the user data 18 acquired at step 258. Namely, the user data 18 acquired at step 258 is sorted into any user data 18 in the usage specific table 52 that is appended with the permitted data, and any user data 18 in the usage specific table 52 that is appended with the not-permitted data.

At the next step 262, the provision section 40 determines whether or not there is any user data 18 permitted to be provided to the application 12 identified by the app identification ID acquired at step 250 present. Namely, the provision section 40 determines whether or not user data 18 appended with the permitted data has been sorted at step 260. Affirmative determination is made at step 262 when there is user data 18 permitted to be provided to the application 12 identified by the app identification ID acquired at step 250 present, and processing proceeds to step 264. Negative determination is made at step 262 when there is no user data 18 permitted to be provided to the application 12 identified by the app identification ID acquired at step 250 present, and processing proceeds to step 266.

At step 266, the presentation section 32 performs error display and then ends the provision processing after sorting. Error display means display for example of a message that there is no user data 18 that may be provided to the application 12 present. Note that explanation has been given of an example in which the user data 18 appended with the permitted data is returned to the originally requesting application 12, and error display is performed when there is no user data 18 appended with the permitted data present, however the technology disclosed herein is not limited thereto. For example, configuration may be made such that not-permitted data is substituted with NULL or meaningless text and then returned (and error display is not performed even when not permitted data).

At step 264, the provision section 40 provides the user data 18 permitted to be provided (the user data 18 appended with the permitted data) to the application 12 identified by the app identification ID acquired at step 250, and then ends the provision processing after sorting.

As explained above, in the smart device 10 according to the first exemplary embodiment, the application 12 that uses user data 18 is associated by the association application section 30 with designated group(s) out of plural groups of the user data 18 classified by usage. Then, from out of the user data 18 belonging to the group associated by the association application section 30, any of the user data 18 appended with the permitted data is supplied by the provision section 40 to the application 12 that requested the user data 18. Thereby, the smart device 10 of the first exemplary embodiment is capable of suppressing user data 18 that does not match the usage being provided to the application 12, with a simple configuration.

Moreover, in the smart device 10 according to the first exemplary embodiment, the contents of the permissibility data appended to the user data 18 is changed according to instruction that have been given. Consequently, the smart device 10 according to the first exemplary embodiment is capable of changing content of the permissibility data to content reflecting the intention of the user, with a simple configuration.

In the smart device 10 according to the first exemplary embodiment, the content of the permissibility data appended to the user data 18 belonging to a designated group out of plural groups is displayed on the display section 76. The display content of the permissibility data on the display section 76 is changed according to given instructions, and then the content of the permissibility data is changed according to the display content after such change. The smart device 10 according to the first exemplary embodiment is accordingly capable of changing content of permissibility data by group (usage) unit, with a simple configuration.

Moreover, in the smart device 10 according to the first exemplary embodiment, when a new application 12 is installed, the setting screen 90B is displayed as information prompting designation of group(s) to be associated with the newly installed application 12. The smart device 10 according to the first exemplary embodiment is thereby capable of making a user aware that there are no groups (usages) associated with the newly installed application 12, with a simple configuration.

Note that although explanation has been given in the first exemplary embodiment of an example in which one usage specific table 52 is associated with one application 12, there is no limitation thereto, and plural of the usage specific tables 52 may be associated with one of the applications 12. In such cases, a user is able to associate plural groups with the one application 12 by pressing the group confirmation button 90B3 in a state in which plural groups have been selected for a single application 12 such as for example through the setting screen 90B illustrated in FIG. 9.

Moreover, in the first exemplary embodiment, an example has been given in which the app identification ID registered in the application list table 56 is associated with the usage specific table 52 through the group list table 54, however the technology disclosed herein is not limited thereto. For example, the app identification ID registered in the application list table 56 may be directly associated with the usage specific table 52 without going through the group list table 54.

In the first exemplary embodiment, explanation has been given of an example in which the processing at installation is performed when the application 12 is installed via the internet, however the technology disclosed herein is not limited thereto. For example, processing equivalent to the processing at installation may be performed when an application 12 is incorporated into the smart device 10 from an external device such as a personal computer or other smartphone connected to the smart device 10 through the external I/F 82.

### Second Exemplary Embodiment

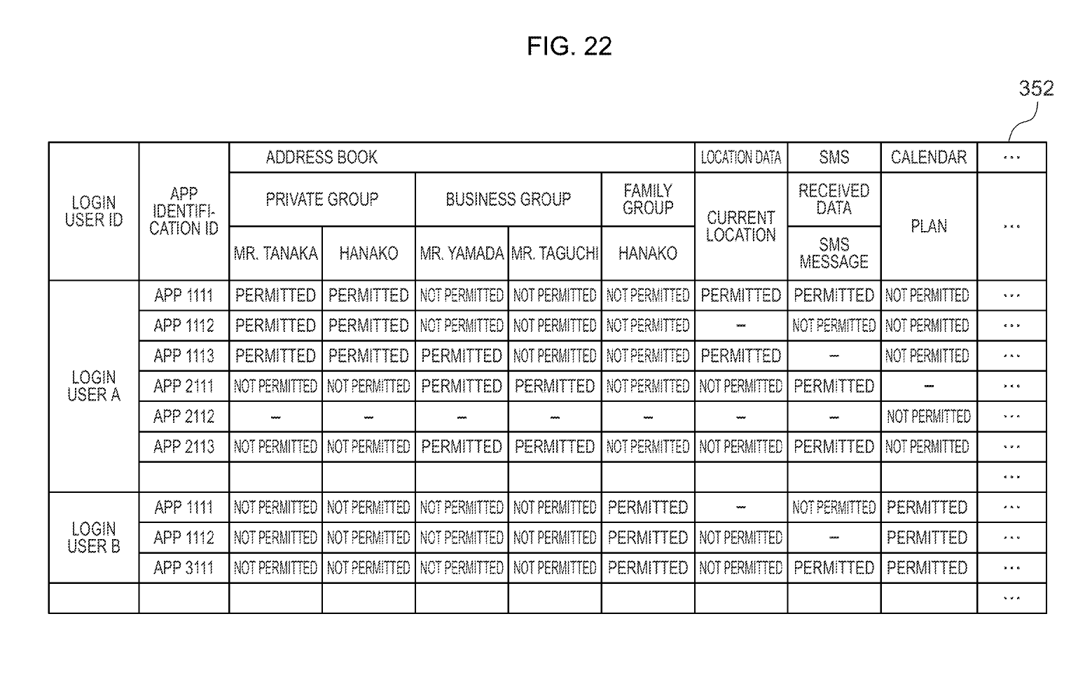

In the first exemplary embodiment, explanation has been given of an example in which the user data 18 is sorted according to the permissibility data designated in the usage specific table 52. However in the second exemplary embodiment, explanation follows regarding a case in which the user data 18 is sorted according to a policy table 352 such as the example illustrated in FIG. 22. Note that portions of the second exemplary embodiment that are similar to portions explained in the first exemplary embodiment are allocated the same reference numerals and further explanation is omitted.

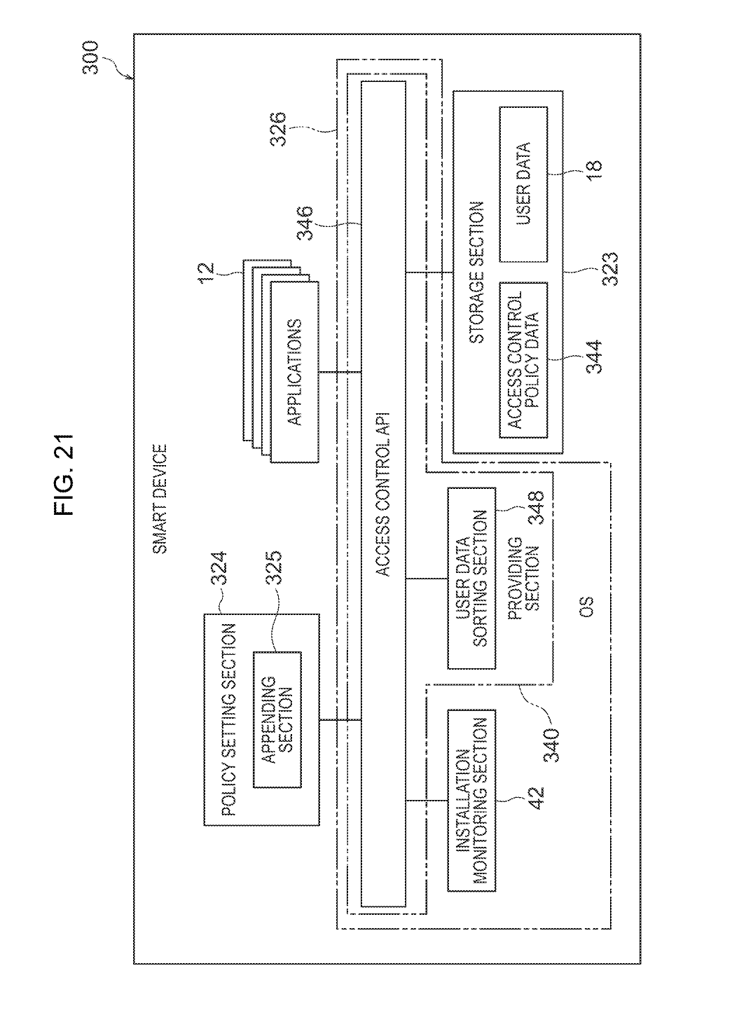

A smart device 300 such as the example illustrated in FIG. 21, differs from the smart device 10 illustrated in FIG. 1 in that a storage section 323 is provided in place of the storage section 23, and in that a policy setting section 324 is provided in place of the policy setting section 24. Moreover, the smart device 300 differs from the smart device 10 in that an OS 326 is provided instead of the OS 26.

The storage section 323 differs from the storage section 23 in that it stores access control policy data 344 instead of the access control policy data 44. The user data 18 is classified into hierarchical levels (for example for each classification) based on the access control policy data 344.

The access control policy data 344 differs from the access control policy data 44 in that it includes a policy table 352 such as the example illustrated in FIG. 22 in place of the usage specific table 52, the group list table 54 and the application list table 56.

The policy table 352 illustrated in FIG. 22 is a table in which associations between classifications and permissibility data etc. applied for each user of the smart device 300 and for each of the already installed applications 12. Permissibility data etc. means permissibility data or NULL. Note that NULL is a value associated with a high level classification set with a false value in the high level classification specification table 58.

In the example illustrated in FIG. 22, app identification IDs of installed applications 12 are associated with each of the login user IDs (referred to below as “user IDs”) that are appended to users of the smart device 300. The classifications are associated with each of the app identification IDs that have been associated with the user IDs. In each of the app identification IDs, the permissibility data etc. is associated with each terminal classification. Terminal classification means the smallest unit of classification out of classifications belonging to the high level classification. Note that a high level classification is employed as the terminal classification when there are no middle level classifications or low level classifications belonging to the high level classification.

The policy setting section 324 differs from the policy setting section 24 illustrated in FIG. 1 in that an appending section 325 is provided in place of the association application section 30, the presentation section 32 and the change section 34. The appending section 325 appends permissibility data etc. to the user data 18 at the hierarchical level unit (for example classification unit) according to instructions.

Out of the user data 18 requested to be provided, a provision section 340 does not provide to the application 12 that has requested provision of the user data 18 any user data 18 appended with not permitted data, and provides any user data 18 appended with permitted data to the application 12 that has requested provision of the user data 18.

The provision section 340 differs from the provision section 40 illustrated in FIG. 1 in that it is provided with an access control API 346 in place of the access control API 46, and with a user data selection section 348 in place of the user data selection section 48.

The access control API 346 receives a requested from the application 12 to provide the user data 18, acquires the access control policy data 344 and the user data 18, and provides the acquired access control policy data 344 and user data 18 to the user data selection section 348. The user data 18 returned from the user data selection section 348 is then provided to the originally requesting application 12.

Based on the access control policy data 344 provided from the access control API 346, the user data selection section 348 sorts the user data 18 into any user data 18 permitted for provision to the originally requesting application 12, and any user data 18 not permitted for provision. Then the user data 18 that is permitted for provision to the originally requesting application 12 is returned to the access control API 346.

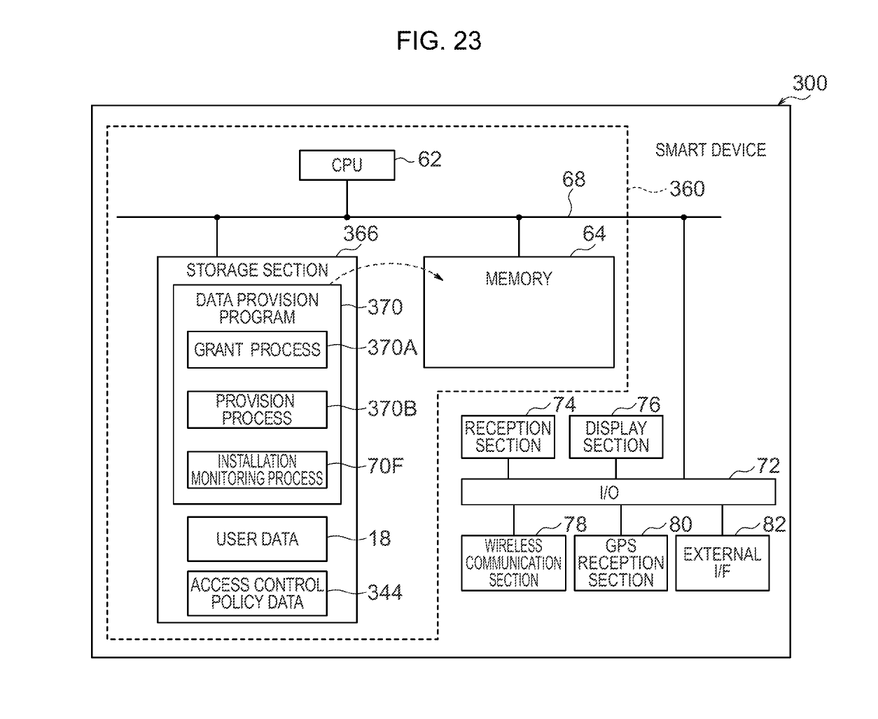

The smart device 300 illustrated in FIG. 23 differs from the smart device 10 illustrated in FIG. 4 in that it is provided with a computer 360 in place of the computer 60. The computer 360 differs from the computer 60 illustrated in FIG. 1 in that it is provided with a storage section 366 in place of the storage section 66. The storage section 366 differs from the storage section 66 illustrated in FIG. 1 in that a data provision program 370 is provided in place of the data provision program 70. The data provision program 370 differs from the data provision program 70 illustrated in FIG. 1 in that the association application process 70A, the presentation process 70B and the conversion process 70C are removed, and it is provided with a presentation process 370B in place of the provision process 70E. The data provision program 370 also differs from the data provision program 70 illustrated in FIG. 1 in that it includes an application process 370A.

The CPU 62 operates as the appending section 325 illustrated in FIG. 21 by executing the application process 370A. The CPU 62 operates as the provision section 340 illustrated in FIG. 21 by executing the presentation process 370B.

Explanation next follows regarding an example of flow of data provision processing performed by the smart device 300 as operation of the second exemplary embodiment, with reference to FIG. 5. Note that the data provision processing according to the second exemplary embodiment is implemented by the data provision program 370 that is stored in the storage section 366 being executed by the CPU 62.

The data provision processing according to the second exemplary embodiment illustrated in FIG. 5 differs from the data provision processing according to the first exemplary embodiment illustrated in FIG. 5 in that it includes a step 402 in place of the step 102, and includes the step 406 in place of the step 106. Moreover, the data provision processing according to the second exemplary embodiment illustrated in FIG. 5 differs from the data provision processing according to the first exemplary embodiment illustrated in FIG. 5 in that it includes a step 410 in place of the step 110.

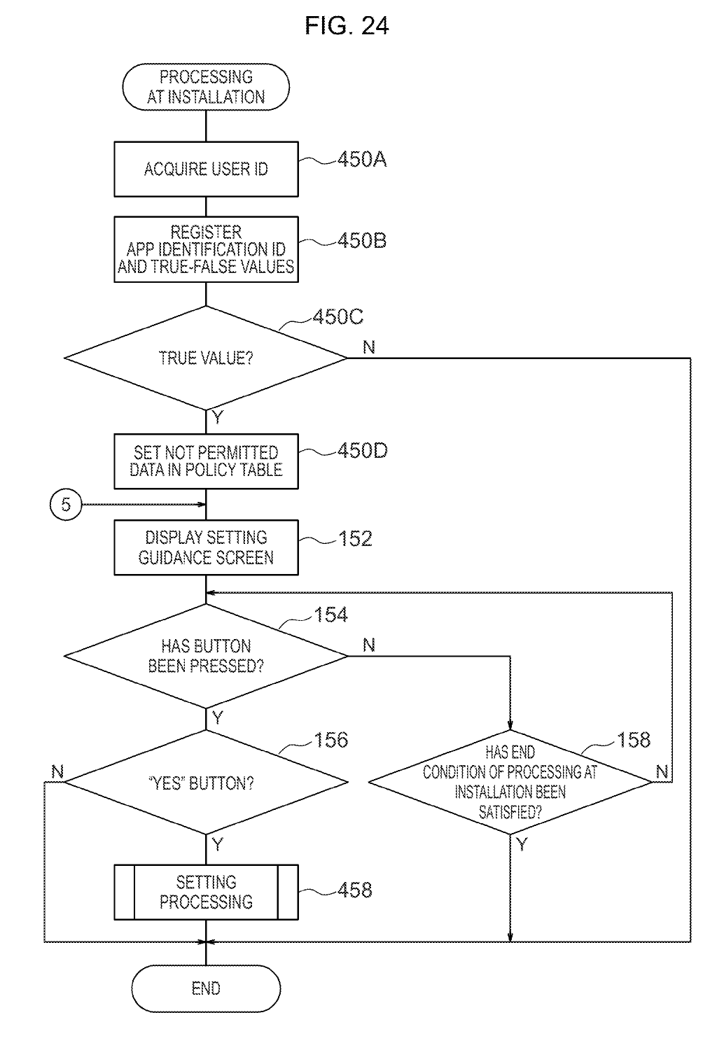

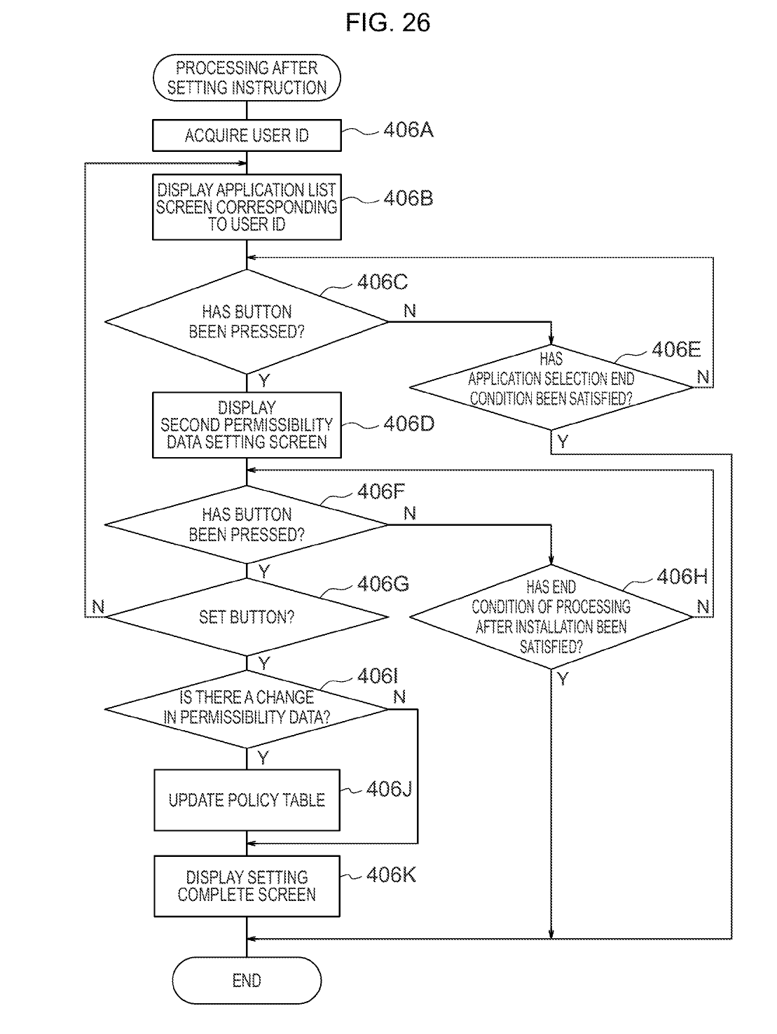

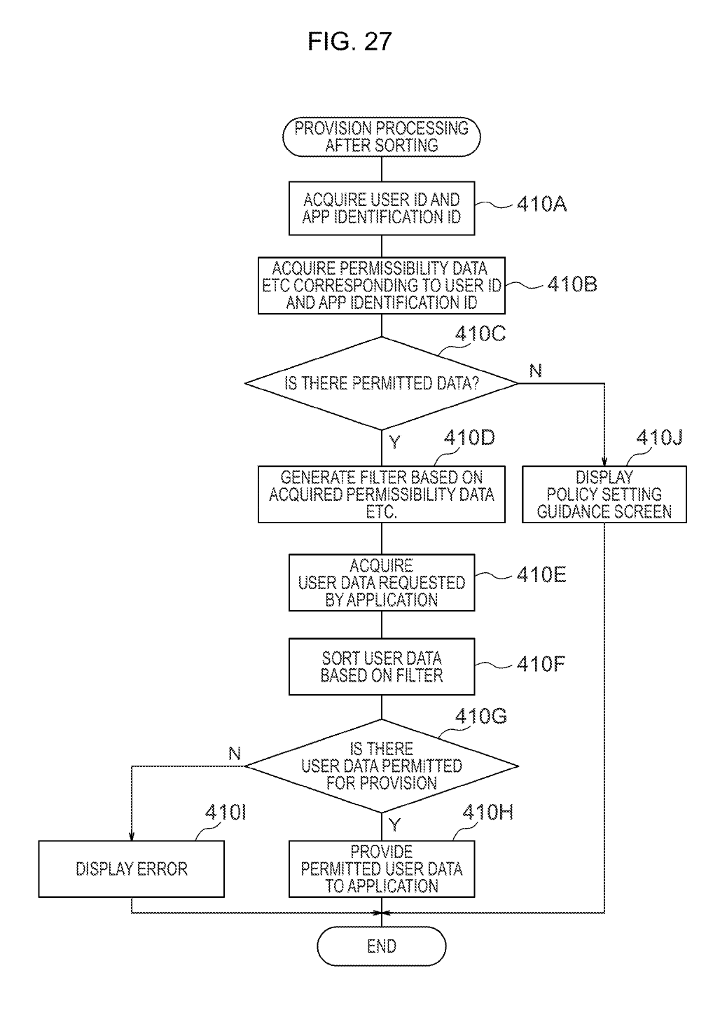

At step 402, the appending section 325 performs processing at installation such as the example illustrated in FIG. 24. At step 406, the appending section 325 performs post setting instruction processing such as the example illustrated in FIG. 26. At step 410, the provision section 340 performs provision processing after sorting such as the example illustrated in FIG. 27.

The processing at installation illustrated in FIG. 24 differs from the processing at installation illustrated in FIG. 6 in that it includes steps 450A, 450B, 450C and 450D in place of step 150, and in that it includes a step 458 in place of the step 158.

At step 450A, the appending section 325 acquires a user ID of a user currently logged in.

At step 450B, the appending section 325 registers an app identification ID related to a newly installed application 12 in a high level classification specification table 58. The appending section 325 also registers true-false values in the high level classification specification table 58. The appending section 325 associates the app identification ID with the user ID acquired in step 450A out of user IDs registered in the policy table 352.

At step 450C, the appending section 325 determines whether or not a true value was registered at step 450B in the high level classification specification table 58. Negative determination is made at step 450C when a true value was not registered in the high level classification specification table 58 at step 450B, and the processing at installation is ended. Affirmative determination is made at step 450C when a true value was registered in the high level classification specification table 58 at step 450B, and processing proceeds to step 450D.

At step 450D, the appending section 325 sets not permitted data for a high level classification for which a true value was associated at step 450B, from out of the high level classifications associated with the app identification IDs registered in the policy table 352 at step 450B. Note that NULL is set for a high level classification for which a false value was associated at step 450B, from out of the high level classifications associated with the app identification IDs registered in the policy table 352 at step 450B.

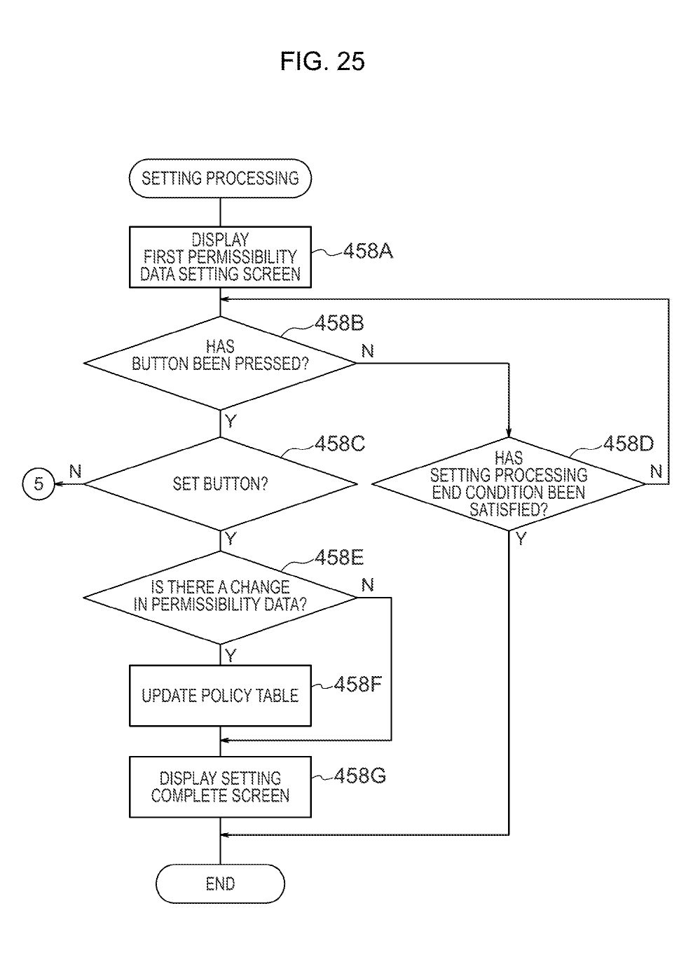

At step 458, the appending section 325 performs setting processing such as the example illustrated in FIG. 25, and then ends the processing at installation.

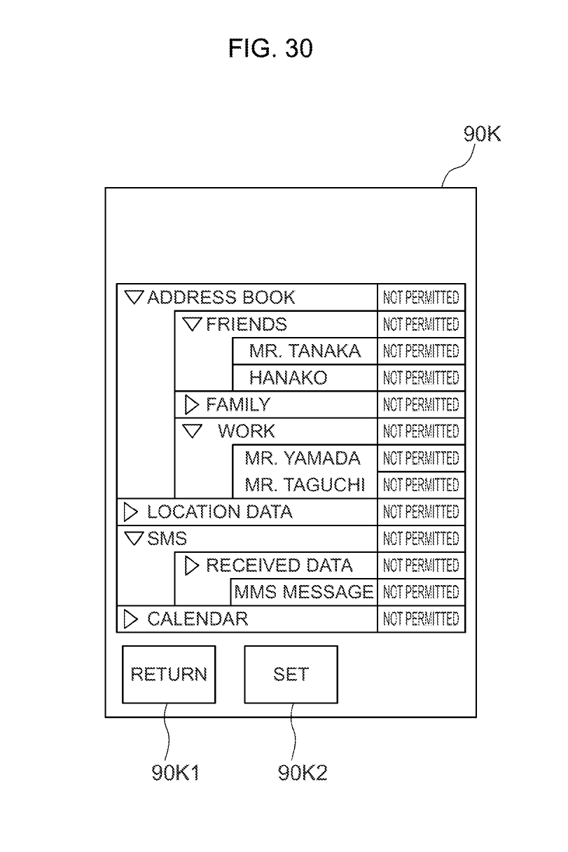

In the setting processing illustrated in FIG. 25, first at step 458A, the appending section 325 displays on the display section 76 a first permissibility data setting screen 90K such as the example illustrated in FIG. 30. The first permissibility data setting screen 90K illustrated in FIG. 30 is, similarly to the first permissibility data setting screen 90C illustrated in FIG. 11, a pull-down display in which not permitted data set for high level classifications at step 450D are displayed in pull-down for each of the classifications according to instructions. A return button 90K1 and a set button 90K2 are displayed on the first permissibility data setting screen 90K.

At the next step 458B, the appending section 325 determines whether or not the return button 90K1 or the set button 90K2 has been pressed. Affirmative determination is made at step 458B when the return button 90K1 or the set button 90K2 has been pressed, and processing proceeds to step 458C. Negative determination is made at step 458B when neither the return button 90K1 nor the set button 90K2 has been pressed, and processing proceeds to step 458D.

At step 458D, the appending section 325 determines whether or not a condition to end the setting processing (a setting processing end condition) has been satisfied. The setting processing end condition indicates for example a condition that the reception section 74 has received an instruction to end setting processing, or a condition that a specific duration (for example 1 minute) has elapsed from when the first permissibility data setting screen 90K was displayed. Negative determination is made at step 458D when the setting processing end condition has not been satisfied, and processing returns to step 458B. Affirmative determination is made at step 458D when the setting processing end condition has been satisfied, and the setting processing is ended.

At step 458C, the appending section 325 determines whether or not the set button 90K2 has been pressed at step 458B. Affirmative determination is made at step 458C when the set button 90K2 has been pressed, and processing proceeds to step 458E. Negative determination is made at step 458C when the return button 90K1 has been pressed, and processing proceeds to step 152 illustrated in FIG. 24.

At step 458E, the appending section 325 determines whether or not there is a change in the display content of the permissibility data in the first permissibility data setting screen 90C displayed at step 458A. At step 458E, negative determination is made at step 458A when there is no change in the display content of permissibility data in the first permissibility data setting screen 90K displayed at step 458A, and processing proceeds to step 458G. Affirmative determination is made at step 458E when there is a change in the display content of the permissibility data in the first permissibility data setting screen 90K displayed at step 458A, and processing proceeds to step 458F.

At step 458F, the appending section 325 updates such that the not permitted data set in the policy table 352 at step 450D is overwritten with contents corresponding to the display content of the permissibility data in the first permissibility data setting screen 90K currently being displayed. When the processing of step 458F has been performed processing proceeds to step 458G.

In step 458G, the appending section 325 displays on the display section 76 a setting complete screen 90D such as the example illustrated in FIG. 12, and then ends the setting processing.

In the post setting instruction processing illustrated in FIG. 26, first at step 406A, the appending section 325 acquires the user ID of the user currently logged in.

At the next step 406B, the appending section 325 displays an application list screen 90F such as the example illustrated in FIG. 16. On the application list screen 90F, the names of applications 12 specified by app identification IDs are displayed associated with the acquired user ID at step 406A.

At the next step 406C, the appending section 325 determines whether or not a set button 90F1 on the application list screen 90F displayed at step 406B has been pressed. Affirmative determination is made at step 406C when the set button 90F1 of the application list screen 90F displayed at step 406B has been pressed, and processing proceeds to step 406D. Negative determination is made at step 406C when the set button 90F1 of the application list screen 90F displayed at step 406B has not been pressed, and processing proceeds to step 406E.

At step 406E, the appending section 325 determines whether or not an application selection end condition has been determined. Affirmative determination is made at step 406E when the application selection end condition has been satisfied, and the post setting instruction processing is ended. The application selection end condition indicates for example a condition that the reception section 74 has received an instruction to end application setting processing, or that a specific duration (for example 1 minute) has elapsed from when the application list screen 90F was displayed. Negative determination is made at step 406E when the application selection end condition has not been satisfied, and processing proceeds to step 406C.

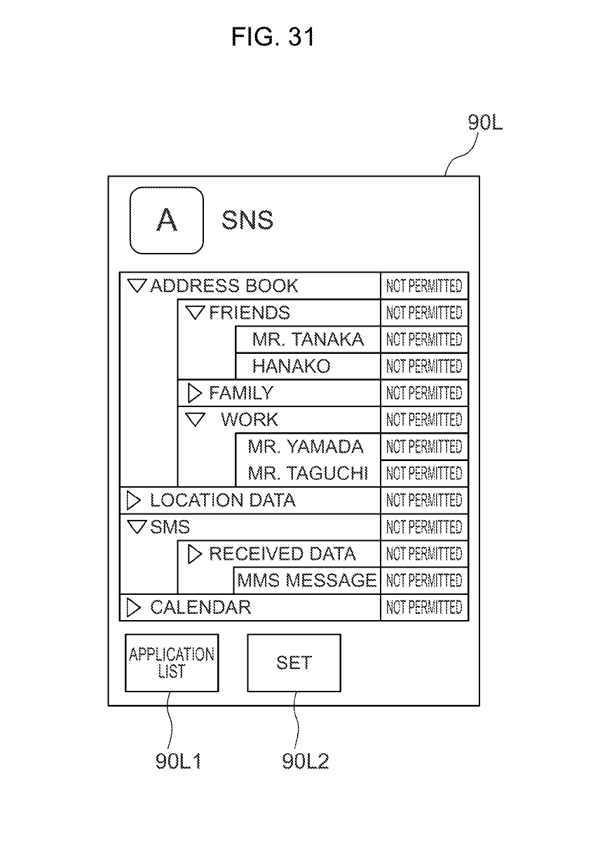

At step 406D, the appending section 325 displays on the display section 76 a second permissibility data setting screen 90L for performing setting of permissibility data, such as the example illustrated in FIG. 31.

The second permissibility data setting screen 90L illustrated in FIG. 31 displays each of the classifications of not permitted data appended at step 450D to the app identification ID of the application 12 set as the processing target by pressing the set button 90F1 at step 406C. An application list button 90L1 and a setting button 90L2 are displayed on the second permissibility data setting screen 90L.

At the next step 406F, the appending section 325 determines whether or not the application list button 90L1 or the setting button 90L2 has been pressed. Affirmative determination is made at step 406F when the application list button 90L1 or the setting button 90L2 has been pressed, and processing proceeds to step 406G. Negative determination is made at step 406F when neither the application list button 90L1 nor the setting button 90L2 has been pressed, and processing proceeds to step 406H.

At step 406H, the appending section 325 determines whether or not a condition to stop displaying the second permissibility data setting screen and end the post setting instruction processing (a post instruction processing end condition) has been satisfied. The post instruction processing end condition indicates for example a condition that the reception section 74 has received an instruction to end the post setting instruction processing, or a condition that a specific duration (for example 1 minute) has elapsed from when the second permissibility data setting screen 90L was displayed. Negative determination is made at step 406H when the post instruction processing end condition has not been satisfied, and processing returns to step 406F. Affirmative determination is made at step 406H when the post instruction processing end condition has been satisfied, and the post setting instruction processing is ended.

At step 406G, the appending section 325 determines whether or not the setting button 90L2 has been pressed at step 406F. Affirmative determination is made at step 406G when the setting button 90L2 has been pressed at step 406F, and processing proceeds to step 406I. Negative determination is made at step 406G when the application list button 90L1 has been pressed at step 406F, and processing returns to step 406B.

At step 406I, the appending section 325 determines whether or not there is a change in the display content of the permissibility data in the second permissibility data setting screen 90L displayed at step 406D. Negative determination is made at step 406I when there has been no change to the display content of the permissibility data in the second permissibility data setting screen 90L displayed at step 406D, and processing proceeds to step 406K. Affirmative determination is made at step 406I when there has been a change to the display content of the permissibility data in the second permissibility data setting screen 90L displayed at step 406D, and processing proceeds to step 406J.

At step 406J, the appending section 325 updates such that the not permitted data set in the policy table 352 at step 450D is overwritten with contents corresponding to the display content of the permissibility data in the second permissibility data setting screen 90L currently being displayed. Processing proceeds to step 406K after the processing of step 406 has been performed.

At step 406K, the appending section 325 displays on the display section 76 the setting complete screen 90D such as the example illustrated in FIG. 12, and then ends the setting processing.

At step 410A in the provision processing after sorting illustrated in FIG. 27, the provision section 340 acquires the user ID of the user currently logged in. The provision section 340 also acquires the app identification ID of the application 12 that requested provision of the user data 18 at step 408 illustrated in FIG. 5.

At the next step 410B, from out of the app identification IDs in the policy table 352 associated with the user ID acquired at step 410A, the app identification ID acquired at step 410A is specified by the provision section 340. Then the permissibility data etc. associated with the specified app identification IDs is acquired from the policy table 352 in a state associated with classification.

At the next step 410C, the provision section 340 determines whether or not permitted data is included in the permissibility data etc. acquired from the policy table 352 at step 410B. Affirmative determination is made at step 410C when the permitted data is included in the permissibility data etc. acquired from the policy table 352 at step 410B, and processing proceeds to step 410D. Negative determination is made at step 410C when the permissibility data is not included in the permissibility data etc. acquired from the policy table 352 at step 410B, and processing proceeds to step 410J.

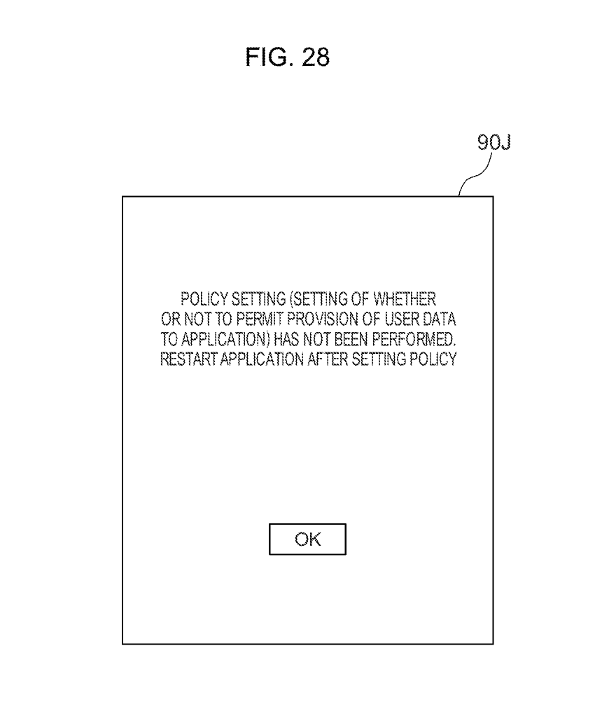

At step 410J, the provision section 340 displays a policy setting guidance screen 90J such as the example illustrated in FIG. 28, and then ends the provision processing after sorting. The policy setting guidance screen 90J is a screen that that works as a warning to prompt a user to restart the application 12 after performing policy setting.

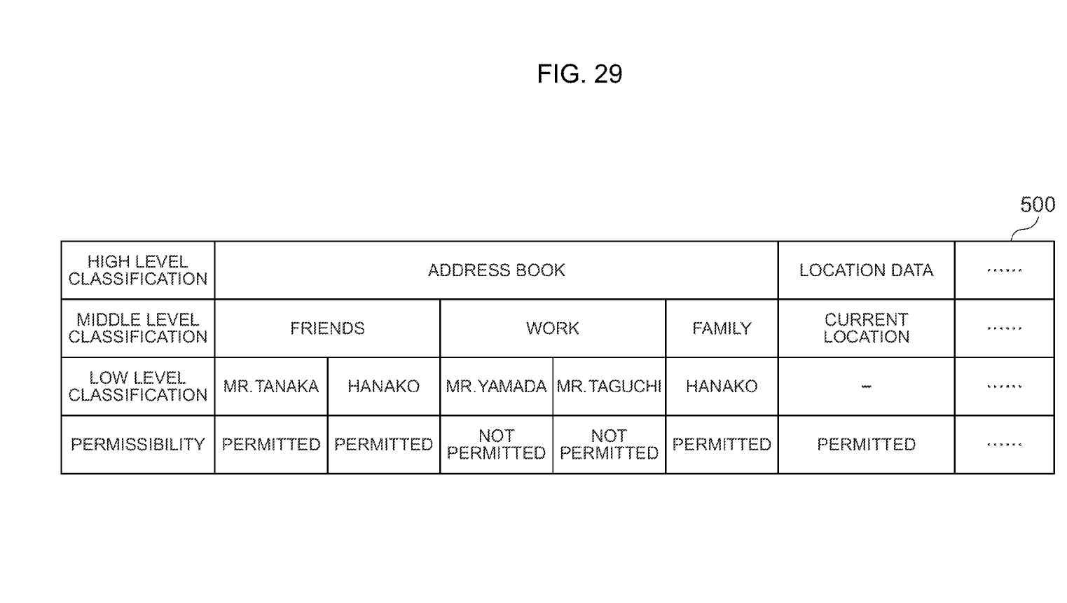

At step 410D, the provision section 340 generates a filter 500 such as the example illustrated in FIG. 29 based on the permissibility data etc. acquired from the policy table 352 at step 410B. In the filter 500, the permissibility data, acquired from the policy table 352 at step 410B in a state associated with the classification, is associated with each of the classifications.

At the next step 410E, the provision section 340 acquires the user data 18 that was requested by the application 12 that requested provision of the user data 18 at step 108 illustrated in FIG. 5.

At the next step 410F, the provision section 340 screens the user data 18 based on the filter 500 generated at step 410D out of the user data 18 acquired at step 410E. Namely, the user data 18 acquired at step 410E is screened into the user data 18 appended with the permitted data in the filter 500, and the user data 18 appended with the not permitted data in the filter 500.

At the next step 410G, the provision section 340 determines whether or not there is any user data 18 permitted to be provided to the application 12 identified by the app identification ID acquired at step 410A present. Namely, determination is made as to whether or not any user data 18 appended with the permitted data has been screened at step 410F. Affirmative determination is made at step 410G when there is user data 18 permitted to be provided to the application 12 identified by the app identification ID acquired at step 410A present, and processing proceeds to step 410H. Negative determination is made at step 410G when there is no user data 18 permitted to be provided to the application 12 identified by the app identification ID acquired at step 410A present, and processing proceeds to step 410I.

In step 410I, a presentation section 32 performs error display, and then ends the provision processing after sorting.

At step 410H, the provision section 340 provides the user data 18 permitted for provision (the user data 18 appended with the permitted data) to the application 12 identified by the app identification ID acquired at step 410A, and then ends the provision processing after sorting.

As explained above, in the smart device 300 according to the second exemplary embodiment, the permissibility data representing whether or not provision of the user data 18 is permitted is appended to the user data 18 for each of the classifications according to instructions. The user data 18 appended with the permitted data out of the user data 18 requested for provision is then provided to the application 12 that requested the provision of the user data 18. The smart device 300 according to the second exemplary embodiment is accordingly capable of suppressing provision to the application 12 of the user data 18 that is unintended by the user, with a simple configuration.

All cited documents, patent applications and technical standards mentioned in the present specification are incorporated by reference in the present specification to the same extent as if the individual cited document, patent application, or technical standard was specifically and individually indicated to be incorporated by reference.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A terminal device comprising:
a memory configured to store data that has been appended with respective permissibility data representing whether or not provision of the data is permitted and that has been classified into a plurality of different usages; and
a processor configured to execute procedure, the procedure comprising:
associating a specific application that requests provision of data stored in the memory with a prescribed usage that has been prescribed from out of the plurality of usages; and
out of data of the prescribed usage that was associated in the associating, not providing to the application that requested data provision any data appended with the permissibility data representing that provision is not permitted, and providing to the application that requested data provision any data appended with the permissibility data representing that provision is permitted.

2. The terminal device of claim 1,
wherein, in the processor configured to execute the procedure, the procedure further comprises:
changing contents of the permissibility data, according to a given instruction.

3. The terminal device of claim 2,
wherein, in the changing, display contents of permissibility data as displayed by a display that displays contents of the permissibility data appended to data of the usage prescribed from out of the plurality of usages are changed according to a given instruction, and then the contents of the permissibility data is changed according to the display contents after changing.

4. The terminal device of claim 3, wherein:
the memory stores data appended with the permissibility data split by hierarchical level; and
the display displays content of the permissibility data appended to the data belonging to a designated hierarchical level out of data of the usage prescribed from out of the plurality of usages.

5. The terminal device of claim 1,
wherein, in the processor configured to execute the procedure, the procedure further comprises:
when the application has been newly introduced, displaying information prompting prescription of usages to associate with the newly introduced application.

6. The terminal device of claim 5,
wherein, in the displaying,
when the new application has been installed, information prompting prescription of a group to associate with the newly installed application is displayed.

7. The terminal device of claim 1,
wherein, the not providing data appended with the permissibility data and providing data appended with the permissibility data included in an operating system.

8. The terminal device of claim 7,
wherein, the not providing data appended with the permissibility data and providing data appended with the permissibility data includes API provided to the application by the operating system.

9. A data processing method comprising:
by a processor, associating a specific application, that requests provision of data stored in a memory which stores stored data that has been appended with respective permissibility data representing whether or not provision of the data is permitted and has been classified into a plurality of different usages, with a prescribed usage that has been prescribed from out of the plurality of usages; and
by the processor, out of data of the prescribed usage that was associated in the associating, not providing to the application that requested data provision any data appended with the permissibility data representing that provision is not permitted, and providing to the application that requested data provision any data appended with the permissibility data representing that provision is permitted.

10. The data processing method of claim 9 further comprising:
by the processor, changing contents of the permissibility data, according to a given instruction.

11. The data processing method of claim 10, wherein:
in the changing, display contents of permissibility data as displayed by a display that displays contents of the permissibility data appended to data of the usage prescribed from out of the plurality of usages are changed according to a given instruction, and then the contents of the permissibility data are changed according to the display contents after changing.

12. The data processing method of claim 9, further comprising:
by the processor, when the application has been newly introduced, displaying information prompting prescription of a group to associate with the newly introduced application.

13. A computer-readable, non-transitory medium having stored therein a program for causing a computer to execute a data processing process, the process comprising:
associating a specific application, that requests provision of data stored in a memory which stores data that has been appended with respective permissibility data representing whether or not provision of the data is permitted and has been classified into a plurality of different usages, with a prescribed usage that has been prescribed from out of the plurality of usages; and
out of data of the prescribed usage that was associated in the associating, not providing to the application that requested data provision any data appended with the permissibility data representing that provision is not permitted, and providing to the application that requested data provision any data appended with the permissibility data representing that provision is permitted.
